(19) United States
(12) Patent Application Publication
(10) Pub. No.: US 2009/0041984 A1
(43) Pub. Date: Feb. 12, 2009

(54) Structured Smudge-Resistant Coatings and Methods of Making and Using the Same

(75) Inventors: Brian T. Mayers, Somerville, MA (US); Joseph M. McLellan, Somerville, MA (US); Karan Chauhan, Cambridge, MA (US); Wajeeh Saadi, Cambridge, MA (US); Kimberly Dickey, Cambridge, MA (US); Sandip Agarwal, Cambridge, MA (US); David Christopher Coffey, Allston, MA (US); Kevin Randall Stewart, Niskayuna, NY (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Nano Terra Inc., Cambridge, MA (US)

(21) Appl. No.: 12/189,485

(22) Filed: Aug. 11, 2008

Related U.S. Application Data
(60) Provisional application No. 60/955,047, filed on Aug. 10, 2007.

(51) Int. Cl. B05D 5/02; B32B 5/00

(52) U.S. Cl. 428/141; 427/256

(57) ABSTRACT

The present invention is directed to smudge-resistant coatings, methods to prepare the coatings, and products prepared by the methods.

### CROSS-REFERENCE TO RELATED APPLICATIONS

This application claims the benefit of the filing date of U.S. Provisional Appl. No. 60/955,047, filed Aug. 10, 2007, which is incorporated herein by reference in its entirety.

### BACKGROUND OF THE INVENTION

1. Field of the Invention

The present invention is directed to smudge-resistant coatings having structured surfaces, methods for making the smudge-resistant coatings, and products prepared by the methods.

2. Background

The user interfaces of many personal electronic devices rely upon touch screens, the performance, lifetime, and appearance of which can be limited by the ability to resist abrasions, scratches, and the like. In addition to abrasion resistance, the buildup of oils, grease, and other ambient materials can create unsightly smudges that can interfere with use and require regular cleaning. Many current screens are made from transparent, rigid thermosetting polymers that are impact resistant, but unfortunately, are also poorly resistant to abrasions and scratches. Thus, these materials are typically protected from damage using a transparent hardcoat. Imparting smudge resistance to, for example, a touch screen can be achieved by the use of a disposable adhesive layer, or by incorporating fluorinated organosilane coupling agents, fluorinated monomers, or fluorinated surfactants into the films. However, fluorinated coatings can be susceptible to abrasion and the like, which can compromise the film quality, as well as their adhesive properties. The integration of an abrasion-resistant and smudge-resistant optically transparent coating has been difficult to achieve. This task is made more complicated due to the presence of pressure-sensitive sensors and electronics used in touch screen displays, which add layers of materials between the light-emitting electronics and the exterior layer of the device. Because textured anti-glare coatings typically utilized in flat panel display devices are placed close to a light source to prevent optical distortion, these materials are infrequently used for touch screen applications where their presence can induce optical distortions and image haze.

What is needed is a distortion-free coating that can be utilized with display devices to provide smudge resistance.

### BRIEF SUMMARY OF THE INVENTION

The present invention provides surfaces resistant to smudges, abrasions, and the like. These smudge-resistant surfaces can be used in electronic device applications, appliances, industrial building and architectural applications, health care applications, as well as the decorative arts. Moreover, the smudge-resistant coatings of the present invention can be prepared efficiently utilizing low-cost fabrication methods.

The present invention is directed to a smudge-resistant, composite coating comprising a matrix and a particulate embedded within, and protruding from, at least a portion of the matrix, wherein the particulate has a refractive index within about 20% of a refractive index of the matrix or less than a refractive index of the matrix. In some embodiments, the particulate has a polydispersity index of at least about 1 or greater. In some embodiments, the particulate is present within the matrix in a concentration gradient having a highest concentration at an exterior surface of the matrix. In some embodiments, the composite coating has a root mean square surface roughness of about 100 nm to about 10 μm.

In some embodiments, the matrix has a refractive index of about 2 or less. In some embodiments, the matrix has a refractive index and the particulate has a refractive index that are within about 20% of each other. In some embodiments, the matrix has a glass transition temperature of about 50° C. to about 250° C.

In some embodiments, the particulate has a D₅₀ of about 100 nm to about 50 μm and a D₉₀ of about 100 μm or less. In some embodiments, the particulate has a refractive index of about 1.5 or less.

In some embodiments, the matrix has a hardness and the particulate has a hardness at least about 2 times greater than the hardness of the matrix.

In some embodiments, an exterior surface of the composite coating comprises a fluorinated moiety. In some embodiments, at least one of the particulate and the matrix comprises a fluorinated moiety. In some embodiments, an exterior surface of the composite coating is substantially free from a coating thereon.

The present invention is also directed to a method for preparing a smudge-resistant, composite coating, the method comprising:
depositing a particulate and a matrix to provide an intermediate film; and
curing the intermediate film to provide a smudge-resistant, composite coating,
   wherein the curing embeds the particulate at least partially in the matrix to provide a smudge-resistant, composite coating having a concentration gradient of the particulate that is greatest at the exterior surface of the matrix, and wherein the composite coating has a root mean square surface roughness of about 100 nm to about 10 μm.

In some embodiments, the method further comprises hardening the matrix.

In some embodiments, the curing and hardening are performed simultaneously.

In some embodiments, the method further comprises at least one of: chemically polishing, mechanically polishing, or thermally polishing the smudge-resistant composite coating.

In some embodiments, the cured particulate has a D₅₀ of about 200 nm to about 50 μm.

The present invention is also directed to a distortion-free, smudge-resistant coating comprising a substrate that is transparent to visible light and having an array of hollow, pointed elements thereon, each element having a height of about 1 μm to about 300 μm and a thickness of about 100 nm to about 100 μm, wherein the thickness of the elements is not more than 30% of the height of the elements, and wherein the elements do not substantially overlap, and wherein the elements comprise a material having a refractive index that is either less than, or not more than 20% greater than, a refractive index of the substrate.

The present invention is also directed to a distortion-free, smudge-resistant optical coating comprising a substrate having an array of optical elements thereon, the optical elements having an infinite focal length and each optical element having a lateral dimension, measured parallel to the substrate, of about 5 μm to about 200 μm, wherein the optical coating has a root mean square surface roughness of about 1 μm to about 100 μm.

In some embodiments, the array of optical elements is selected from: an array of compound lenses, an array of prisms, a sawtooth grating, a square-wave grating, a sigmoidal grating, an array of trigonal pyramids, an array of square pyramids, and combinations thereof.

In some embodiments, an exterior surface of an array of optical elements comprises a fluorinated moiety.

The present invention is also directed to a method for preparing a distortion-free, smudge-resistant optical coating, the method comprising forming on a substrate a layer comprising an array of optical elements, wherein the substrate and the layer are transparent to visible light, wherein the optical elements have an infinite focal length, the optical elements have a lateral dimension, measured parallel to the substrate, of about 5 μm to about 200 μm, and the layer has an exterior surface having a root mean square surface roughness of about 1 μm to about 100 μm.

In some embodiments, the forming comprises:
depositing a first layer of a first material on the substrate, wherein the first layer includes a surface having a first three-dimensional pattern thereon;
depositing a second layer of a second material on the first layer, wherein the second material includes a surface having a second three-dimensional pattern thereon;
depositing a third layer of a third material on the second layer, wherein the third layer includes a surface having a third three-dimensional pattern thereon,
   wherein the first, second and third three-dimensional patterns are optically aligned to provide an array of optical elements having an infinite focal length, and wherein the first, second and third materials are transparent to visible light. In some embodiments, the depositing comprises molding a material with an elastomeric stamp including a surface having at least one indentation therein.

In some embodiments, the optical coating has a refractive index less than a refractive index of the substrate.

The present invention is also directed to a method for preparing a smudge-resistant film, the method comprising depositing a matrix onto a substrate, and exposing the substrate to an abrasive to produce the smudge-resistant film, wherein the film has a root mean square surface roughness of about 100 nm to about 10 μm.

In some embodiments, the method further comprises curing the matrix.

In some embodiments, the method further comprises at least one of: chemically, mechanically, or thermally polishing the smudge-resistant film.

In some embodiments, the method further comprises surface treating the smudge-resistant film to render an exterior surface of the film hydrophobic.

The present invention is also directed to a product prepared by a method of the present invention.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIGS. 1A-1C provide cross-sectional representations of surfaces having a smudge thereon.

FIG. 2 provides a schematic cross-sectional representation of a smudge-resistant surface of the present invention.

FIGS. 3 and 4 provide schematic cross-sectional representations of distortion-free, smudge-resistant coatings of the present invention.

FIGS. 5A-5B provide a schematic cross-sectional representation of a method for providing a smudge-resistant surface of the present invention.

FIGS. 6A-6C provide a schematic cross-sectional representation of a method for providing a smudge-resistant surface of the present invention.

FIGS. 7A-7D provide schematic cross-sectional representations of protrusions suitable for use with the present invention.

FIG. 8 provides a schematic cross-sectional representation of a protrusion on a curved substrate suitable for use with the present invention.

FIGS. 9A-9B provide schematic cross-sectional representations of gratings suitable for use as a smudge-resistant coating of the present invention.

FIGS. 10, 11, 12, 13, 14 and 15 provide schematic cross-sectional representations of ray-trace diagrams showing light scattering by various patterned surfaces.

One or more embodiments of the present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

References to spatial descriptions (e.g., “above”, “below”, “up”, “down”, “top”, “bottom,” etc.) made herein are for purposes of description and illustration only, and should be interpreted as non-limiting upon the tools, substrates, coatings, methods, and products of any method of the present invention, which can be spatially arranged in any orientation or manner.

### Substrates and Articles

In some embodiments, the smudge-resistant films of the present invention are formed on a substrate. Substrates suitable for use with the present invention are not particularly limited by size, shape, or composition, and suitable substrates include planar, curved, circular, wavy, and topographically patterned substrates.

Substrates for use with the present invention are not particularly limited by size.

The surface area of a substrate is not particularly limited can be easily scaled by the proper design of equipment suitable for depositing the smudge-resistant coatings of the present invention, and can range from about 0.1 mm² to about 100 m². In some embodiments, a substrate suitable for use with the present invention has a surface area of about 0.1 mm² or less, about 1 mm² or less, or about 1 cm² or less. In some embodiments, a substrate for use with the present invention has a surface area of about 10 cm² or more, about 100 cm² or more, about 1 m or more, about 1.5 m² or more, about 2 m² or more, about 5 m² or more, about 10 m² or more, or about 100 m² or more. In some embodiments, a substrate for use with the present invention has a surface area of about 1 cm² to about 1 m², about 2 cm² to about 500 cm², about 10 cm² to about 300 cm², about 20 cm², about 50 cm², or about 100 cm².

Substrates for use with the present invention are not particularly limited by shape or geometry, and include planar and non-planar substrates. A substrate is “non-planar” when any four points lying on the surface of a substrate do not lie in the same plane. Non-planar substrates of the present invention can be curved or faceted, or a combination thereof, including both symmetric and asymmetric non-planar substrates. In some embodiments, a non-planar substrate can include a surface of a spherical, an ellipsoidal, a conical, a cylindrical, a polyhedral, a trigonal pyramidal, or a square pyramidal object, or a combination thereof. The non-planar substrates can be smooth, roughened, pocked, wavy, terraced, and any combination thereof.

A substrate is “curved” when the radius of curvature of a substrate is non-zero over a distance on the surface of about 100 μm or more, or over a distance on the surface of about 1 mm or more. For a curved substrate, a lateral dimension is defined as the magnitude of a segment of the circumference of a circle connecting two points on opposite sides of the surface feature, wherein the circle has a radius equal to the radius of curvature of the substrate. A lateral dimension of a curved substrate having multiple or undulating curvature, or waviness, can be determined by summing the magnitude of segments from multiple circles. In some embodiments, a curved substrate can be patterned using the present invention in combination with a soft lithographic method such as microtransfer molding, mimic, micro-molding, and combinations thereof.

In some embodiments, a non-planar substrate comprises an exterior surface of a solid of revolution. As used herein, a “solid of revolution” is a solid figure obtained by rotating a plane figure around a straight line (the axis) that lies on the same plane as the figure.

The substrates can be homogeneous or heterogeneous in composition. Substrates suitable for use with the present invention include, but are not limited to, metals and alloys thereof, crystalline materials, amorphous materials, insulators (i.e., an electrically insulating material), conductors, semiconductors, optics, fibers, inorganic materials, glasses, ceramics (e.g., metal oxides, metal nitrides, metal silicides, and combinations thereof), zeolites, polymers, plastics, thermosetting and thermoplastic materials (e.g., optionally doped: polyacrylates, polycarbonates, polyurethanes, polystyrenes, cellulosic polymers, polyolefins, polyamides, polyimides, resins, polyesters, polyphenylenes, and the like), painted surfaces, organic materials, wood, minerals, biomaterials, living tissue, bone, films thereof, thin films thereof, laminates thereof, foils thereof, composites thereof, and combinations thereof. Additionally, suitable substrates include both rigid and flexible materials. In some embodiments, the substrates are transparent, translucent, or opaque to visible, UV, and/or infrared light). In some embodiments, a substrate is selected from a porous variant of any of the above materials.

In some embodiments, a substrate comprises a semiconductor such as, but not limited to: crystalline silicon, polycrystalline silicon, amorphous silicon, p-doped silicon, n-doped silicon, silicon oxide, silicon germanide, germanium, gallium arsenide, gallium arsenide phosphide, indium tin oxide, and combinations thereof.

In some embodiments, a substrate comprises a glass such as, but not limited to, undoped silica glass (SiO₂), fluorinated silica glass, borosilicate glass, borophosphorosilicate glass, organosilicate glass, porous organosilicate glass, and combinations thereof.

In some embodiments, a non-planar substrate comprises pyrolytic carbon, reinforced carbon-carbon composite, a carbon phenolic resin, and the like, and combinations thereof.

In some embodiments, a substrate comprises a ceramic such as, but not limited to, silicon carbide, hydrogenated silicon carbide, silicon nitride, silicon carbonitride, silicon oxynitride, silicon oxycarbide, and combinations thereof.

In some embodiments, a substrate comprises a flexible material, such as, but not limited to: a plastic, a metal, a composite thereof, a laminate thereof, a thin film thereof, a foil thereof, and combinations thereof. In some embodiments, a flexible material can be patterned by the method of the present invention in a reel-to-reel or roll-to-roll manner.

The present invention is also directed to articles and products prepared by a method of the present invention. Articles and products for use with, and prepared by a method of the present invention include, but are not limited to, windows; mirrors; optical elements (e.g, optical elements for use in eyeglasses, cameras, binoculars, telescopes, and the like); lenses (e.g., fresnel lenses, etc.); watch crystals; hologram displays; cathode ray tube display devices (e.g., computer and television screens); optical filters; data storage devices (e.g., compact discs, DVD discs, CD-ROM discs, and the like); flat panel electronic displays (e.g., LCDs, plasma displays, and the like); touch-screen displays (such as those of computer touch screens and personal data assistants); solar cells; flexible electronic displays (e.g., electronic paper and books); cellular phones; global positioning systems; calculators; graphic articles (e.g., signage); motor vehicles (e.g., wind screens, windows, mirrors, displays, interior cabin surfaces, and the like); artwork (e.g., sculptures, paintings, lithographs, and the like); membrane switches; jewelry and other decorative articles; and combinations thereof.

In some embodiments, a substrate incorporates a light source. For example, a substrate can comprise a phosphor, a light-emitting diode layer, an organic light-emitting diode layer, a fluorophore, a chromophore layer, and the like, and combinations thereof, wherein the coatings of the present invention do not substantially distort the emitted light.

The present invention is also directed to optimizing the performance, efficiency, cost, and speed of the methods described herein by selecting substrates and materials that are compatible with one another. For example, in some embodiments, a substrate can be selected based upon its physical properties, optical transmission properties, thermal properties, electrical properties, and combinations thereof. In some embodiments, a substrate is transparent to at least one type of radiation suitable for initiating a reaction on the substrate.

### Smudge-Resistant Coatings

The present invention is directed to a smudge-resistant, composite coating comprising a matrix and a particulate embedded within, and protruding from, at least a portion of the matrix. In some embodiments, the particulate has a refractive index within about 20% of a refractive index of the matrix or less than a refractive index of the matrix. In some embodiments, the particulate has a polydispersity index of at least about 1 or greater, and the particulate is present within the matrix in a concentration gradient having a highest concentration at an exterior surface of the matrix. In some embodiments, the composite coating has a root mean square surface roughness of about 100 nm to about 10 μm.

The present invention is also directed to a distortion-free, smudge-resistant optical coating comprising a substrate having an array of optical elements thereon. In some embodiments, the optical elements have an infinite focal length and each optical element has a lateral dimension, measured parallel to the substrate, of about 5 μm to about 200 μm. In some embodiments, the optical coating has a root mean square surface roughness of about 1 μm to about 100 μm.

The present invention is also directed to a distortion-free, smudge-resistant coating comprising a substrate that is transparent to visible light and having an array of hollow, pointed elements thereon. In some embodiments, each element has a height of about 1 μm to about 300 μm and a thickness of about 100 nm to about 100 μm, wherein the thickness of the elements is not more than 30% of the height of the elements, and wherein the elements do not substantially overlap. In some embodiments, the elements comprise a material having a refractive index that is either less than, or not more than 20% greater than, a refractive index of the substrate.

As used herein, a “coating” refers to a film, layer, or surface, having an area. In some embodiments, the present invention is directed to a composite coating. As used herein, a “composite coating” refers to a film comprising distinct components such as, for example, a matrix and a particulate and/or a coating comprising multiple layers.

The films and coatings of the present invention are smudge-resistant. As used herein, a “smudge” refers to a residue that can be deposited on a film surface. A residue can include dirt, a particulate (e.g., diesel exhaust, soot, and the like), an oil (e.g., a composition that is immiscible with water), a vapor (e.g., water and steam, as well as environmental vapors such as fog, clouds, smog, and the like), a component of human and/or animal perspiration (e.g., an exudate from the apocrine glands, merocrine glands, sebaceous glands, and the like), oils produced by the hair and/or skin of human and/or animal, other biological compositions (e.g., saliva, blood, skin flakes, hair, excrement, other waste, and the like), and combinations thereof.

As used herein, “roughness” refers to a topography of a surface or an irregularity in a surface of a film or coating as measured by the root-mean square (rms) of the surface variations. The rms roughness of a surface is based on finding a median level for a surface of a film or coating and evaluating the standard deviation from this median level. The rms roughness, R, for a surface can be calculated using equation (1):

$$R = \sqrt{\frac{1}{{N}^{2}} {\sum }_{i = 1}^{N} {\sum }_{j = 1}^{N} {( H ( i , j ) - \overline{H} )}^{2}} \qquad ( 1 )$$

wherein i and j describe a location on the surface, H is the average value of the height across the entire surface, and N is the number of data points sampled on the surface.

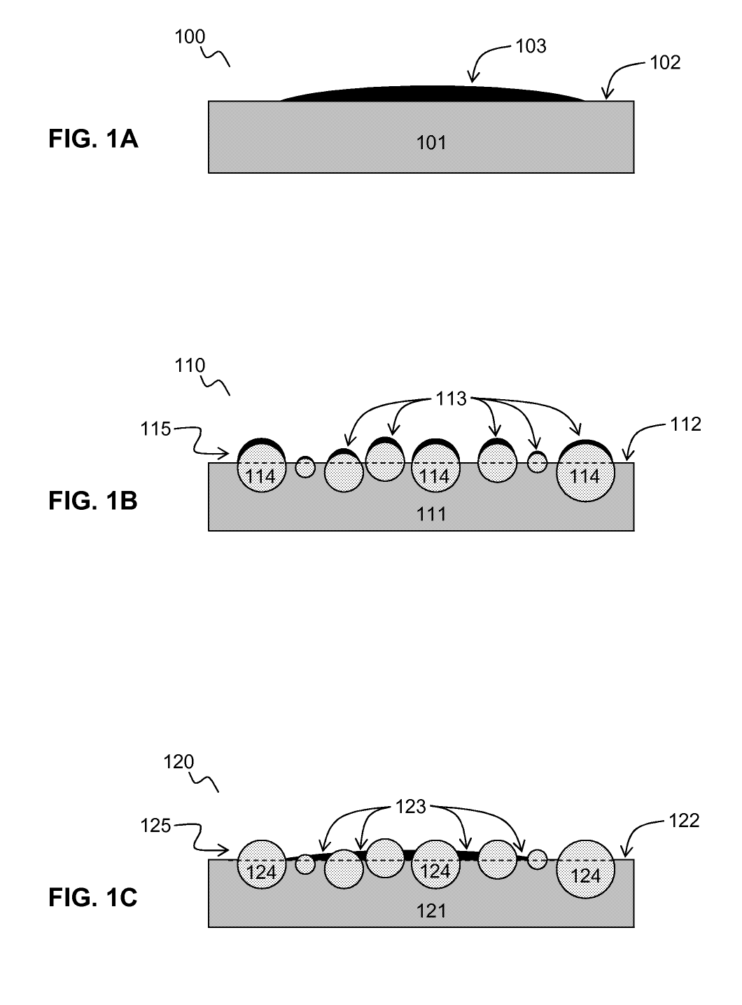

A sufficient surface roughness is important in making the structured coatings of the present invention resistant to smudges. Not being bound by any particular theory, a smudge coats a smooth surface in a substantially even or conformal manner. Referring to FIG. 1A, a cross-sectional representation, 100, of a substrate, 101, having a smooth surface, 102, is provided. A smudge, 103, is present on the smooth surface. The presence of a smudge on a smooth (i.e., “non-roughened”) surface can be visible to the human eye due to any of: light absorption by the smudge material, refractive distortion of light by the smudge material, back reflection of light at the smudge-air interface and/or the smudge-surface interface, for example.

Roughened surfaces provide several advantages for reducing the visibility of a smudge compared to smooth surfaces. First, a roughened surface provides a reduced surface area suitable for contacting. Thus, in some embodiments a smudge is transferred only to the upper areas of a substrate, and a smudge coats a roughened surface in a substantially uneven manner. Referring to FIG. 1B, a cross-sectional representation, 110, of a substrate, 111, having a surface, 112, with a particulate, 114, protruding therefrom, 115, is provided. A smudge on the surface, 113, transferred by physical contact, is localized to the raised regions of the substrate. Thus, the reduced surface area of a roughened surface provides superior resistance to retention of a smudge. Moreover, protrusions and valleys of a roughened surface can mitigate the effect of light absorption by a smudge because light can be reflected or emitted through one of the two areas of the substrate, depending upon where a smudge is localized.

A composite surface having a roughened morphology can also be heterogeneously functionalized whereby, for example, the surface energy and/or hydrophobicity of a substrate and a particulate protruding therefrom differs. Referring to FIG. 1C, a cross-sectional representation, 120, of a substrate, 121, having a surface, 122, with a particulate, 124, protruding therefrom, 125, is provided. A smudge on the surface, 123, is localized to the regions of the surface between the protrusions. In some embodiments, a smudge, 123, is less detectable because a roughened surface can “absorb” a smudge.

Not being bound by any particular theory, the schematic provided in FIG. 1C can be realized by hydrophobic functionalization of the particulate, 124. The surface, 122, can be hydrophobic or hydrophilic.

At least a portion of the particulate protrudes from the matrix surface. When a portion of the particulate protrudes from the matrix, this can increase the roughness of the films. In some embodiments, this can improve both the smudge and abrasion resistance of the films of the present invention.

In some embodiments, a smudge-resistant, composite coating comprising a matrix and a particulate embedded within, and protruding from, at least a portion of the matrix, has a rms surface roughness of about 100 nm to about 10 μm, about 200 nm to about 10 μm, about 500 nm to about 10 μm, about 1 μm to about 10 μm, about 2 μm to about 10 μm, about 5 μm to about 10 μm, about 1 μm, about 2 μm, about 5 μm, or about 10 μm.

In some embodiments, a distortion-free, smudge-resistant optical coating comprising an array of optical elements thereon has a rms surface roughness of about 1 μm to about 100 μm, about 1 μm to about 80 μm, about 1 μm to about 60 μm, about 1 μm to about 50 μm, about 1 μm to about 25 μm, about 1 μm to about 20 μm, about 1 μm to about 15 μm, about 1 μm to about 10 μm, about 10 μm to about 100 μm, about 10 μm to about 80 μm, about 10 μm to about 50 μm, about 10 μm to about 25 μm, about 25 μm to about 100 μm, about 25 μm to about 80 μm, about 25 μm to about 50 μm, about 40 μm to about 100 μm, about 50 μm to about 100 μm, about 60 μm to about 100 μm, about 70 μm to about 100 μm, or about 80 μm to about 100 μm.

In some embodiments, a distortion-free, smudge-resistant optical coating comprising an array of hollow elements has a rms surface roughness of about 1 μm to about 300 μm, about 1 μm to about 250 μm, about 1 μm to about 200 μm, about 1 μm to about 150 μm, about 1 μm to about 100 μm, about 1 μm to about 75 μm, about 1 μm to about 50 μm, about 1 μm to about 25 μm, about 1 μm to about 10 μm, about 5 μm to about 300 μm, about 5 μm to about 200 μm, about 5 μm to about 100 μm, about 10 μm to about 300 μm, about 10 μm to about 200 μm, about 10 μm to about 100 μm, about 25 μm to about 300 μm, about 25 μm to about 200 μm, about 25 μm to about 100 μm, about 50 μm to about 300 μm, about 50 μm to about 200 μm, about 100 μm to about 300 μm, or about 200 μm to about 300 μm.

In some embodiments, a film or coating of the present invention is hydrophobic. As used herein, “hydrophobic” refers to films and coatings that have a tendency to repel water, are resistant to water and/or cannot be wetted by water. For example, in some embodiments water deposited on a hydrophobic coating of the present invention forms a droplet having a contact angle of about 90° to about 180°. In some embodiments, water deposited onto a hydrophobic coating of the present invention forms a minimum contact angle of about 90°, about 100°, about 110°, about 120°, about 130°, about 140°, about 150°, or about 160°. In some embodiments, a hydrophobic coating of the present invention has a surface free energy of about 40 dynes/cm or less, about 35 dynes/cm or less, about 30 dynes/cm or less, about 25 dynes/cm or less, or about 20 dynes/cm or less.

In some embodiments, a hydrophobic coating comprises a polymer. Non-limiting examples of hydrophobic polymers include, by way of illustration only, polyolefins (e.g., polyethylene, poly(isobutene), poly(isoprene), poly(4-methyl-1-pentene), polypropylene, ethylene-propylene copolymers, ethylene-propylene-hexadiene copolymers, and the like); ethylene-vinyl acetate copolymers; styrene polymers (e.g., poly(styrene), poly(2-methylstyrene), styrene-acrylonitrile copolymers having less than about 20 mole-percent acrylonitrile, styrene-2,2,3,3,-tetrafluoropropyl methacrylate copolymers, and the like); halogenated hydrocarbon polymers (e.g., poly(chloro-trifluoroethylene), chlorotrifluoroethylene-tetrafluoroethylene copolymers, poly(hexa-fluoropropylene), poly(tetrafluoroethylene), tetrafluoroethylene-ethylene copolymers, poly(vinyl fluoride), poly(trifluoroethylene), poly(vinylidene fluoride), and the like); vinyl polymers (e.g., poly(vinylbutyrate), poly(vinyldecanoate), poly(vinylhexanoate), poly(vinylpropionate), poly(vinyldodecanoate), poly(vinylhexadecanoate), poly(heptafluoro-iso-propoxyethylene), 1-heptafluoro-iso-propoxymethylethylene-maleic acid copolymers, poly(vinyloctanoate), poly(heptafluoro-iso-propoxypropylene), poly(methacrylonitrile), poly(vinylalcohol), poly(vinylbutyral), poly(ethoxyethylene), poly(methoxyethylene), poly(vinylformal), and the like); acrylic polymers (e.g., poly(n-butylacetate), poly(ethylacrylate), poly[(1-chlorodifluoromethyl)tetrafluoroethyl acrylate], poly[di-(chlorofluoromethyl)fluoromethyl acrylate], poly(1,1-dihydroheptafluorobutyl acrylate), poly(1,1-dihydropenta-fluoro-iso-propyl acrylate), poly(1,1-dihydropentadecafluorooctyl acrylate), poly(hepta-fluoro-iso-propyl acrylate), poly[5-(heptafluoro-iso-propoxy)pentyl acrylate], poly[11-(heptafluoro-iso-propoxy)undecyl acrylate], poly[2-(heptafluoropropoxy)ethyl acrylate], and poly (nonafluoro-iso-butyl acrylate), and the like); methacrylic polymers (e.g., poly(benzyl methacrylate), poly(n-butyl methacrylate), poly(iso-butyl methacrylate), poly(tert-butyl methacrylate), poly(tert-butylaminoethyl methacrylate), poly(dodecyl methacrylate), poly(ethyl methacrylate), poly(2-ethylhexyl methacrylate), poly(n-hexyl methacrylate), poly(dimethylaminoethyl methacrylate), poly(hydroxyethyl methacrylate), poly(phenyl methacrylate), poly(n-propyl methacrylate), poly(octadecyl methacrylate), poly(1,1-dihydropentadecafluorooctyl methacrylate), poly(heptafluoro-iso-propyl methacrylate), poly(heptadecafluorooctyl methacrylate), poly(1-hydrotetrafluoroethyl methacrylate), poly(1-hydrohexafluoroisopropyl methacrylate), poly(1,1-dihydrotetrafluoropropyl methacrylate), and poly(tert-nonafluorobutyl methacrylate); polyethers (e.g., poly(chloral), poly(oxybutene)diol, poly(oxyisobutene)diol, poly(oxydecamethylene), poly(oxyethylene)dimethyl ether polymers having molecular weights of about 1,500 Da or less, poly(oxyhexamethylene)diol, poly(oxypropylene)diol, poly(oxypropylene)-dimethylether, poly(oxytetramethylene), and the like); polyether copolymers (e.g., poly(oxyethylene)-poly(oxypropylene)-poly(oxyethylene) block copolymers, oxyethylene-oxypropylene copolymers having about 20 mol-% or more of oxypropylene, oxytetra-methylene-oxypropylene copolymers, block copolymers having oxyethylene-oxypropylene copolymer blocks separated by a poly(oxydimethylsilylene) block, and the like); polyamides (e.g., poly[imino(1-oxodecamethylene)], poly[imino(1-oxotetramethylene)] or nylon 4, poly[imino(1-oxododecamethylene)] or nylon 12, poly[imino(1-oxohexamethylene)] or nylon 6, poly(iminosuberoyliminooctamethylene), poly(iminoazelaoyliminononamethylene), poly(iminosebacoyliminodecamethylene), and the like); polyimines (e.g., poly[(benzoylimino)ethylene], poly[(butyrylimino)ethylene], poly[(dodecanoylimino)ethylene], poly[(hexanoylimino)ethylene], poly[(heptanoylimino)ethylene], (dodecanoylimino)ethylene-(acetyleimino)-trimethylene copolymers, poly[(pentanoylimino)ethylene], poly{[(3-methyl)butyrylimino]ethylene}, poly[(pentadecafluorooctadecanoylimino)ethylene], and the like); polyurethanes (e.g., copolymers of methylenediphenyl di-iso-cyanate and butanediol, copolymers of poly(oxytetramethylene)diol, copolymers of hexamethylene di-iso-cyanate and triethylene glycol, copolymers of 4-methyl-1,3-phenylene di-iso-cyanate and tripropylene glycol, and the like); polysiloxanes e.g., poly(oxydimethylsilylene), poly(oxymethylphenylsilylene), and the like; cellulosic polymers (e.g., amylose, amylopectin, cellulose acetate butyrate, ethylcellulose, hemicellulose, nitrocellulose, and the like), and combinations thereof.

In some embodiments, a film or coating of the present invention is functionalized or derivatized with a moiety to impart a hydrophobic characteristic to the film or coating. Thus, in some embodiments, a film or coating comprises a group selected from an optionally substituted C₁-C₃₀ alkyl, an optionally substituted C₂-C₃₀ alkenyl, an optionally substituted C₂-C₃₀ alkynyl, an optionally substituted C₆-C₃₀ aryl, an optionally substituted C₆-C₃₀ aralkyl, an optionally substituted C₆-C₃₀ heteroaryl, and combinations thereof, wherein these groups can be linear or branched. Optional substituents for the hydrophobic coating groups include, but are not limited to, a halo and perhalo (i.e., wherein halo is any one of: fluorine, chlorine, bromine, iodine, and combinations thereof), alkylsilyl, alkoxy, siloxyl, tertiary amino, and combinations thereof.

In some embodiments, an optionally substituted hydrophobic coating material is selected from a C₁-C₃₀ fluoroalkyl, a C₁-C₃₀ perfluoroalkyl, and combinations thereof.

As used herein, “alkyl,” by itself or as part of another group, refers to straight and branched chain hydrocarbons of up to 30 carbon atoms, such as, but not limited to, octyl, decyl, dodecyl, hexadecyl, and octadecyl.

As used herein, “alkenyl,” by itself or as part of another group, refers to a straight and branched chain hydrocarbons of up to 30 carbon atoms, wherein there is at least one double bond between two of the carbon atoms in the chain, and wherein the double bond can be in either of the cis or trans configurations, including, but not limited to, 2-octenyl, 1-dodecenyl, 1-8-hexadecenyl, 8-hexadecenyl, and 1-octadecenyl.

As used herein, “alkynyl,” by itself or as part of another group, refers to straight and branched chain hydrocarbons of up to 30 carbon atoms, wherein there is at least one triple bond between two of the carbon atoms in the chain, including, but not limited to, 1-octynyl and 2-dodecynyl.

As used herein, “aryl,” by itself or as part of another group, refers to cyclic, fused cyclic and multi-cyclic aromatic hydrocarbons containing up to 30 carbons in the ring portion. Typical examples include phenyl, naphthyl, anthracenyl, fluorenyl, tetracenyl, pentacenyl, hexacenyl, perylenyl, terylenyl, quaterylenyl, coronenyl, and fullerenyl.

As used herein, “aralkyl” or “arylalkyl,” by itself or as part of another group, refers to alkyl groups as defined above having at least one aryl substituent, such as benzyl, phenylethyl, and 2-naphthylmethyl. Similarly, the term “alkylaryl,” as used herein by itself or as part of another group, refers to an aryl group, as defined above, having an alkyl substituent, as defined above.

As used herein, “heteroaryl,” by itself or as part of another group, refers to cyclic, fused cyclic and multicyclic aromatic groups containing up to 30 atoms in the ring portions, wherein the atoms in the ring(s), in addition to carbon, include at least one heteroatom. The term “heteroatom” is used herein to mean an oxygen atom (“0”), a sulfur atom (“S”) or a nitrogen atom (“N”). Additionally, the term heteroaryl also includes N-oxides of heteroaryl species that containing a nitrogen atom in the ring. Typical examples include pyrrolyl, pyridyl, pyridyl N-oxide, thiophenyl, and furanyl.

As used herein, “alkylsilyl,” by itself or as part of another group, refers to an (—Si(R)ₓH_{y}) moiety, wherein 1≦x≦3 and y=3−x, and wherein R is independently an optionally fluorinated, linear or branched C₁-C₈ alkyl, alkenyl, or alkynyl.

As used herein, “alkoxy,” by itself or as part of another group, refers to a (—OR) moiety, wherein R is selected from alkyl, alkenyl, alkynyl, aryl, aralkyl, and heteroaryl groups described above.

As used herein, “siloxyl,” by itself or as part of another group, refers to a (—Si(OR)ₓR_{y}) moiety, wherein 1≦x≦3 and y=3−x, wherein R and R¹ are independently selected from hydrogen and the alkyl, alkenyl, alkynyl, aryl, aralkyl, and heteroaryl groups described above.

As used herein, “tertiary amino,” by itself or as part of another group, refers to an (—NRR¹) moiety, wherein R and R¹ are independently an optionally fluorinated, linear or branched C₁-C₈ alkyl, alkenyl, or alkynyl group.

In some embodiments, a film of the present invention can further comprise a fluorinated moiety. As used herein, a “fluorinated moiety” refers to a molecule, particulate, polymer, oligomer, or precursor within the composite coating, or that is used to prepare the composite coating, that contains a bond to fluorine. Thus, the fluorinated moiety can be present in and/or on the matrix and/or the particulate of a film. For example, in some embodiments, a particulate can be fluorinated on its surface (i.e., by exposure to F₂, SiF₄, SF₆, a fluorinated alkyl and/or alkoxy silane, and the like, as well as other fluorination methods that would be apparent to a person of ordinary skill in the art of surface fluorination) to provide a fluorinated particulate. In some embodiments, fluorinated particulates prepared by such a method have fluorine groups present only on the outer surface of the particulate. Alternatively, a particulate can be made from a fluorinated polymer or molecule such that fluorinated groups are present throughout the particulate. In some embodiments, a matrix can comprise a fluorinated moiety, or can be surface treated to deposit a fluorine coating after deposition of the matrix. For example, a fluorine-containing glass particulate can be prepared from a mixture of alkoxysilane precursors comprising fluoro-triethoxysilane, or another alkoxysilane comprising a Si—F bond and/or a C—F bond. In another example, deposition of a carbon-doped inorganic glass that can be etched by a fluorine species can be both roughened and functionalized with fluorinated moieties by, for example, exposure to a fluorine-containing plasma.

Other suitable reagents include, but are not limited to, exposure to dilute HF, exposure to a downstream plasma, exposure to a fluorinating species (e.g., Selectfluor®, Air Products and Chemicals, Inc., Allentown, Pa.), and combinations thereof. In some embodiments, a fluorinated moiety comprises a C—F bond.

In some embodiments, a smudge-resistant coating has a refractive index that is not more than 20% greater than a refractive index of the substrate, or is about equal to that of the substrate. In some embodiments, the smudge-resistant coating has a refractive index that is less than that of a refractive index of the substrate. For example, the refractive index of the smudge-resistant coating can be about 10% less, about 15% less, about 20% less, about 25% less, about 30% less, about 35% less, about 40% less, about 45% less, or about 50% less than the refractive index of the substrate.

As used herein, a “matrix” refers to a material capable of forming a film on a substrate. In some embodiments, materials suitable for use as a matrix are transparent to visible light. Materials suitable for use as a matrix with the present invention include, but are not limited to, polymers, glasses (e.g., inorganic and organic-doped oxides), crystalline and polycrystalline materials (e.g., quartz), and combinations thereof.

In some embodiments, a material suitable for use as a matrix has a refractive index, n_{M}, of about 1.1 to about 2.2, about 1.2 to about 2.2, about 1.3 to about 2.2, about 1.4 to about 2.2, about 1.5 to about 2.2, about 1.2 to about 2.0, about 1.3 to about 1.9, about 1.4 to about 1.8, about 1.3, about 1.35, about 1.4, about 1.45, about 1.5, about 1.55, about 1.6, or about 1.7.

Polymers suitable for use with the present invention include, but are not limited to those polymers listed in Table 1.

TABLE 1
Polymers suitable for use with the present invention and the refractive indices
thereof.

| Polymer | R.I. | Polymer | R.I. |
|---|---|---|---|
| Poly(hexafluoropropyleneoxide) | 1.301 | Poly(1-methylcyclohexyl | 1.511 |
| | | methacrylate) | |
| Hydroxypropylcellulose | 1.337 | Poly(2-hydroxyethyl | 1.512 |
| | | methacrylate) | |
| Poly(tetrafluoroethylene-co- | 1.338 | Isotactic Poly(1-butene) | 1.513 |
| hexafluoropropylene) | | | |
| Alginic acid, sodium salt | 1.334 | Poly(vinylmethacrylate) | 1.513 |
| Fluorinated Ethylene Propylene | 1.338 | Poly(vinylchloroacetate) | 1.513 |
| Poly(pentadecafluorooctyl acrylate) | 1.339 | Poly(N-butylmethacrylamide) | 1.514 |
| Poly(tetrafluoro-3- | 1.346 | Poly(2-chloroethyl | 1.517 |
| (heptafluoropropoxy) | | methacrylate) | |
| propylacrylate) | | | |
| Poly(tetrafluoro-3- | 1.348 | Poly(methyl-α-chloroacrylate) | 1.517 |
| (pentafluoroethoxy)propyl acrylate) | | | |
| Poly(tetrafluoroethylene) | 1.35 | Poly(2-diethylamino | 1.517 |
| | | ethylmethacrylate) | |
| Tetrafluoroethylene | 1.35 | Poly(2-chlorocyclohexyl | 1.518 |
| hexafluoropropylene vinylidene | | methacrylate) | |
| fluoride | | | |
| Poly(undecafluorohexyl acrylate) | 1.356 | Poly(1,4-butadiene)(35% cis; | 1.518 |
| | | 56% trans; 7% 1,2-content) | |
| Tetrafluoroethylene | 1.34 | Poly(acrylonitrile) | 1.519 |
| Poly(nonafluoropentyl acrylate) | 1.36 | Poly(cis-isoprene) | 1.519 |
| Poly(tetrafluoro-3- | 1.36 | Poly(allylmethacrylate) | 1.52 |
| (trifluoromethoxy)propyl acrylate) | | | |
| Poly(heptafluorobutyl acrylate) | 1.367 | Poly(methacrylonitrile) | 1.52 |
| Poly(trifluorovinyl acetate) | 1.375 | Poly(methylisopropenylketone) | 1.52 |
| Poly(octafluoropentyl acrylate) | 1.38 | Poly(butadiene-co-acrylonitrile) | 1.52 |
| Poly(methyl 3,3,3-trifluoropropyl | 1.383 | Poly(2-ethyl-2-oxazoline) | 1.52 |
| siloxane) | | | |
| Poly(pentafluoropropyl acrylate) | 1.385 | Poly(N-2-methoxyethyl) | 1.5246 |
| | | methacrylamide | |
| Poly(2-heptafluorobutoxy)ethyl | 1.39 | Poly(2,3-dimethylbutadiene) | 1.525 |
| acrylate) | | | |
| Poly(chlorotrifluoroethylene) | 1.39 | Poly(2-chloro-1-(chloromethyl) | 1.527 |
| | | ethylmethacrylate) | |
| Poly(2,2,3,4,4-hexafluorobutyl | 1.392 | Poly(1,3-dichloropropyl | 1.527 |
| acrylate) | | methacrylate) | |
| Poly(methyl hydro siloxane) | 1.397 | Poly(acrylicacid) | 1.527 |
| Poly(methacrylic acid), sodium salt | 1.401 | Poly(N-vinylpyrrolidone) | 1.53 |
| Poly(dimethyl siloxane) | 1.404 | Poly(caprolactam) | 1.53 |
| Poly(trifluoroethyl acrylate) | 1.407 | Poly(butadiene-co- | 1.53 |
| | | styrene)(30%) styrene)block | |
| | | copolymer | |
| Poly(2-(1,1,2,2-tetrafluoroethoxy) | 1.412 | Poly(cyclohexyl-α-chloro | 1.532 |
| ethylacrylate) | | acrylate) | |
| Poly(trifluoroisopropyl | 1.418 | Poly(methylphenylsiloxane) | 1.533 |
| methacrylate) | | | |
| Poly(2,2,2-trifluoro-1-methylethyl | 1.419 | Poly(2-chloroethyl-α- | 1.533 |
| methacrylate) | | chloroacrylate) | |
| Poly(2-trifluoroethoxyethyl | 1.419 | Poly(butadiene-co- | 1.535 |
| acrylate) | | styrene)(75/25) | |
| Poly(vinylidenefluoride) | 1.42 | Poly(2-aminoethyl | 1.537 |
| | | methacrylate) | |
| Ethylene Chlorotrifluorotheylene | 1.447 | Poly(furfurylmetacrylate) | 1.538 |
| Poly(trifluoroethylmethacrylate) | 1.437 | Poly(vinylchloride) | 1.539 |
| Poly(methyloctadecylsiloxane) | 1.443 | Poly(butylmercaptyl | 1.539 |
| | | methacrylate) | |
| Poly(methylhexylsiloxane) | 1.443 | Poly(1-phenyl-n-amyl | 1.54 |
| | | methacrylate) | |
| Poly(methyloctylsiloxane) | 1.445 | Poly(N-methylmethacrylamide) | 1.54 |
| Poly(iso-butylmethacrylate) | 1.447 | Polyethylene, high density | 1.54 |
| Poly(vinylisobutylether) | 1.451 | Cellulose | 1.54 |
| Poly(methylhexadecylsiloxane) | 1.451 | Poly(cyclohexyl-α-bromo | 1.542 |
| | | acrylate) | |
| Poly(ethyleneoxide) | 1.454 | Poly(sec-butyl-α-bromo | 1.542 |
| | | acrylate) | |
| Poly(vinylethylether) | 1.454 | Poly(2-bromoethyl | 1.543 |
| | | methacrylate) | |
| Poly(methyltetradecyl siloxane | 1.455 | Poly(dihydroabietic acid) | 1.544 |
| Poly(ethyleneglycol mono-methyl | 1.456 | Poly(abietic acid) | 1.546 |
| ether) | | | |
| Poly(vinyl-n-butyl ether) | 1.456 | Poly(ethylmercaptyl | 1.547 |
| | | methacrylate) | |
| Poly(propylene oxide) | 1.457 | Poly(N-allylmethacrylamide) | 1.548 |
| Poly(3-butoxypropylene oxide) | 1.458 | Poly(1-phenylethyl | 1.549 |
| | | methacrylate) | |
| Poly(3-hexoxypropylene oxide) | 1.459 | Poly(2-vinyltetrahydrofuran) | 1.55 |
| Poly(ethylene glycol) | 1.459 | Poly(vinylfuran) | 1.55 |
| Poly(vinyl-n-pentyl ether) | 1.459 | Poly(methyl-meta- | 1.55 |
| | | chlorophenylethyl siloxane) | |
| Poly(vinyl-n-hexyl ether) | 1.459 | Poly(para-methoxybenzyl | 1.552 |
| | | methacrylate) | |
| Poly(4-fluoro-2-trifluoromethyl | 1.46 | Poly(iso-propylmethacrylate) | 1.552 |
| styrene) | | | |
| Poly(vinyloctylether) | 1.461 | Poly(para-isopropylstyrene) | 1.554 |
| Poly(vinyl-n-octyl acrylate) | 1.461 | Poly(isoprene), chlorinated | 1.554 |
| Poly(vinyl-2-ethylhexyl ether) | 1.463 | Poly(para,para′-xylylenyl | 1.556 |
| | | dimethacrylate) | |
| Poly(vinyl-n-decyl ether) | 1.463 | Poly(cyclohexylmethylsilane) | 1.557 |
| Poly(2-methoxyethyl acrylate) | 1.463 | Poly(1-phenylallyl | 1.557 |
| | | methacrylate) | |
| Poly(acryloxypropyl | 1.463 | Poly(para-cyclohexylphenyl | 1.558 |
| methylsiloxane) | | methacrylate) | |
| Poly(4-methyl-1-pentene) | 1.463 | Poly(chloroprene) | 1.558 |
| Poly(3-methoxypropylene oxide | 1.463 | Poly(2-phenylethyl | 1.559 |
| | | methacrylate) | |
| Poly(tert-butyl methacrylate) | 1.464 | Poly(methyl-meta-chlorophenyl | 1.56 |
| | | siloxane) | |
| Poly(vinyl n-dodecyl ether) | 1.464 | Poly{4,4-heptane bis(4-phenyl) | 1.56 |
| | | carbonate} | |
| Poly(3-ethoxypropyl acrylate) | 1.465 | Poly{1-(ortho-chlorophenyl) | 1.562 |
| | | ethyl methacrylate)} | |
| Poly(vinyl propionate) | 1.467 | Styrene/maleic anhydride | 1.564 |
| | | copolymer | |
| Poly(vinylacetate) | 1.467 | Poly(1-phenylcyclohexyl | 1.564 |
| | | methacrylate) | |
| Poly(vinylpropionate) | 1.467 | Poly(hexamethylene | 1.565 |
| | | adipamide) | |
| Poly(vinylmethylether) | 1.467 | Poly(trimethylhexamethylene | 1.566 |
| | | terephthalamide) | |
| Poly(ethylacrylate) | 1.469 | Poly(2,2,2′- | 1.566 |
| | | trimethylhexamethylene | |
| | | terephthalamide) | |
| Poly(vinylmethylether)(isotactic) | 1.47 | Poly(methyl-α-bromoacrylate) | 1.567 |
| Poly(3-methoxypropylacrylate) | 1.471 | Poly(benzyl methacrylate) | 1.568 |
| Poly(1-octadecene) | 1.471 | Poly{2-(phenylsulfonyl)ethyl | 1.568 |
| | | methacrylate} | |
| Poly(2-ethoxyethyl acrylate) | 1.471 | Poly(meta-cresyl methacrylate) | 1.568 |
| Poly(isopropylacrylate) | 1.473 | Styrene/acrylonitrile copolymer | 1.57 |
| Poly(1-decene) | 1.473 | Poly(ortho-methoxyphenol | 1.571 |
| | | methacrylate) | |
| Poly(propylene)(atactic) | 1.474 | Poly(phenyl methacrylate) | 1.571 |
| Poly(lauryl methacrylate) | 1.474 | Poly(ortho-cresyl methacrylate) | 1.571 |
| Poly(vinyl sec-butyl ether) | 1.474 | Poly(diallyl phthalate) | 1.572 |
| (isotactic) | | | |
| Poly(n-butylacrylate) | 1.474 | Poly(2,3-dibromopropyl | 1.574 |
| | | methacrylate) | |
| Poly(dodecylmethacrylate) | 1.474 | Poly(2,6-dimethyl-para- | 1.575 |
| | | phenylene oxide) | |
| Poly(ethylenesuccinate) | 1.474 | Poly(ethylene terephthalate) | 1.575 |
| Poly(tetradecylmethacrylate) | 1.475 | Poly(vinyl benozoate) | 1.577 |
| Poly(hexadecylmethacrylate) | 1.475 | Poly{2,2-propane bis[4-(2- | 1.578 |
| | | methylphenyl)]carbonate} | |
| Celluloseacetatebutyrate | 1.475 | Poly{1,1-butane bis(4- | 1.579 |
| | | phenyl)carbonate} | |
| Celluloseacetate | 1.475 | Poly(1,2-diphenylethyl | 1.582 |
| | | methacrylate) | |
| Poly(vinylformate) | 1.476 | Poly(ortho-chlorobenzyl | 1.582 |
| | | methacrylate) | |
| Ethylene/vinyl acetate copolymer- | 1.476 | Poly(meta-nitrobenzyl | 1.585 |
| 40% vinyl acetate | | methacrylate) | |
| Poly(2-fluoroethyl methacrylate) | 1.477 | Poly(oxycarbonyloxy-1,4- | 1.585 |
| | | phenyleneisopropylidene-1,4- | |
| | | phenylene) | |
| Poly(octylmethylsilane) | 1.478 | Poly{N-(2- | 1.586 |
| | | phenylethyl)methacrylamide} | |
| Ethylcellulose | 1.479 | Poly{1,1-cyclohexane bis[4- | 1.586 |
| | | (2,6-dichlorophenyl)] | |
| | | carbonate} | |
| Poly(methyl acrylate) | 1.479 | Polycarbonate resin | 1.586 |
| Poly(dicyanopropyl siloxane) | 1.48 | Bisphenol-A Polycarbonate | 1.586 |
| Poly(oxymethylene) | 1.48 | Poly(4-methoxy-2-methyl | 1.587 |
| | | styrene) | |
| Poly(sec-butyl methacrylate) | 1.48 | Poly(ortho-methyl styrene) | 1.587 |
| Poly(dimethylsiloxane-co-α- | 1.48 | Polystyrene | 1.589 |
| methylstyrene) | | | |
| Poly(n-hexyl methacrylate) | 1.481 | Poly{2,2-propane bis[4-(2- | 1.59 |
| | | chlorophenyl)]carbonate} | |
| Ethylene/vinyl acetate copolymer- | 1.482 | Poly{1,1-cyclohexane bis(4- | 1.59 |
| 33% vinyl acetate | | phenyl)carbonate} | |
| Poly(n-butyl methacrylate) | 1.483 | Poly(ortho-methoxy styrene) | 1.593 |
| Poly(ethylidene dimethacrylate) | 1.483 | Poly(diphenylmethyl | 1.593 |
| | | methacrylate) | |
| Poly(2-ethoxyethyl methacrylate) | 1.483 | Poly{1,1-ethane-bis(4- | 1.594 |
| | | phenyl)carbonate} | |
| Poly(n-propyl methacrylate) | 1.484 | Poly(propylene sulfide) | 1.596 |
| Poly(ethylene maleate) | 1.484 | Poly(para-bromophenyl | 1.596 |
| | | methacrylate) | |
| Ethylene/vinylacetate copolymer- | 1.485 | Poly(N-benzylmethacrylamide) | 1.597 |
| 28% vinylacetate | | | |
| Poly(ethylmethacrylate) | 1.485 | Poly(para-methoxy styrene) | 1.597 |
| Poly(vinylbutyral) | 1.485 | Poly(4-methoxystyrene) | 1.597 |
| Poly(vinylbutyral)-11% hydroxyl | 1.485 | Poly{1,1-cyclopentane bis(4- | 1.599 |
| | | phenyl)carbonate} | |
| Poly(3,3,5- | 1.485 | Poly(vinylidene chloride) | 1.6 |
| trimethylcyclohexylmethacrylate) | | | |
| Poly(2-nitro-2- | 1.487 | Poly(ortho-chlorodiphenyl | 1.604 |
| methylpropylmethacrylate) | | methyl methacrylate) | |
| Poly(dimethylsiloxane-co- | 1.488 | Poly{2,2-propane-bis[4-(2,6- | 1.606 |
| diphenylsiloxane) | | dichlorophenyl)]carbonate} | |
| Poly(1,1-diethylpropyl | 1.489 | Poly(pentachlorophenyl | 1.608 |
| methacrylate) | | methacrylate) | |
| Poly(triethylcarbinylmethacrylate) | 1.489 | Poly(2-chlorostyrene) | 1.609 |
| Poly(methylmethacrylate) | 1.489 | Poly(α-methylstyrene) | 1.61 |
| Poly(2-decyl-1,4-butadiene) | 1.49 | Poly(phenyl α-bromoacrylate) | 1.612 |
| Isotactic Poly(propylene) | 1.49 | Poly{2,2-propane bis[4-(2,6- | 1.614 |
| | | dibromophenyl)carbonate]} | |
| Poly(vinylbutyral)-19% hydroxyl | 1.49 | Poly(para-divinylbenzene) | 1.615 |
| Poly(mercaptopropylmethyl | 1.49 | Poly(N-vinyl phthalimide) | 1.62 |
| siloxane) | | | |
| Poly(ethylglycolate methacrylate) | 1.49 | Poly(2,6-dichlorostyrene) | 1.625 |
| Poly(3-methylcyclohexyl | 1.495 | Poly(chloro-para-xylene) | 1.629 |
| methacrylate) | | | |
| Poly(cyclohexyl-α-ethoxyacrylate) | 1.497 | Poly(β-naphthylmethacrylate) | 1.63 |
| Methylcellulose | 1.497 | Poly(α-naphthylcarbonyl | 1.63 |
| | | methacrylate) | |
| Poly(4- | 1.498 | Polyetherimide | 1.687 |
| methylcyclohexylmethacrylate) | | | |
| Poly(decamethyleneglycol | 1.499 | Poly(phenyl methyl silane) | 1.63 |
| dimethacrylate) | | | |
| Poly(vinylalcohol) | 1.5 | Poly[4,4′-isopropylidene | 1.633 |
| | | diphenoxy-di(4-phenylene) | |
| | | sulfone] | |
| Poly(vinylformal) | 1.5 | Polysulfone resin | 1.633 |
| Poly(2-bromo-4-trifluoromethyl | 1.5 | Poly(2-vinylthiophene) | 1.638 |
| styrene) | | | |
| Poly(1,2-butadiene) | 1.5 | Polyethyleneterephthalate | 1.64-1.67 |
| Poly(sec-butyl-α-chloroacrylate) | 1.5 | Poly(2,6-diphenyl-1,4- | 1.64 |
| | | phenylene oxide) | |
| Poly(2-heptyl-1,4-butadiene) | 1.5 | Poly(α-naphthyl methacrylate) | 1.641 |
| Poly(vinylmethylketone) | 1.5 | Poly(para-phenylene ether- | 1.65 |
| | | sulphone) | |
| Poly(ethyl-α-chloroacrylate) | 1.502 | Poly[diphenylmethane-bis(4- | 1.654 |
| | | phenyl)carbonate] | |
| Poly(vinylformal) | 1.502 | Poly(vinylphenylsulfide) | 1.657 |
| Poly(2-iso-propyl-1,4-butadiene) | 1.502 | Poly(styrenesulfide) | 1.657 |
| Poly(2- | 1.503 | Butylphenolformaldehyde resin | 1.66 |
| methylcyclohexylmethacrylate) | | | |
| Poly(bornylmethacrylate) | 1.506 | Poly(para-xylylene) | 1.67 |
| Poly(2-tert-butyl-1,4-butadiene) | 1.506 | Poly(2-vinylnapthalene) | 1.682 |
| Poly(ethyleneglycoldimethacrylate) | 1.506 | Poly(N-vinyl carbazole) | 1.683 |
| Poly(cyclohexylmethacrylate) | 1.507 | Naphthalene-formaldehyde | 1.696 |
| | | rubber | |
| Poly(cyclohexanediol-1,4- | 1.507 | Phenol-formaldehyde resin | 1.7 |
| dimethacrylate) | | | |
| Butyl rubber(unvulcanized) | 1.508 | Poly(pentabromophenyl | 1.71 |
| | | methacrylate) | |
| Poly(tetrahydrofurfuryl | 1.51 | Amorphous | 1.65-1.71 |
| methacrylate) | | Polyetheretherketone (“PEEK”) | |
| Poly(isobutylene) | 1.51 | Crystalline | 1.68-1.77 |
| | | Polyetheretherketone (“PEEK”) | |
| Low Density Polyethylene | 1.51 | Poly(methyl-iso- | 1.52 |
| | | propenylketone) | |
| Ethylene/methacrylic acid, sodium | 1.51 | | |
| salt | | | |
| Polyethylene | 1.51 | | |
| Cellulose nitrate | 1.51 | | |
| Polyethylene ionomer | 1.51 | | |
| Polyacetal | 1.51 | | |

In some embodiments, a matrix and/or a polymer suitable for use in a coating of the present invention has a glass transition temperature of about 50° C. to about 250° C., about 60° C. to about 250° C., about 70° C. to about 250° C., about 80° C. to about 250° C., about 90° C. to about 250° C., about 100° C. to about 250° C., about 115° C. to about 250° C., about 130° C. to about 250° C., about 145° C. to about 250° C., about 160° C. to about 250° C., about 50° C. to about 250° C., about 50° C. to about 230° C., about 50° C. to about 210° C., about 50° C. to about 190° C., or about 50° C. to about 170° C. Non-limiting exemplary materials suitable for use as a matrix include: polyethylene terephthalate (“PET”), which has a T_{g} of about 70° C.; polyvinyl alcohol (“PVA”), which has a T_{g} of about 85° C.; polyvinylchloride (“PVC”), which has a T_{g} of about 80° C.; polystyrene, which has a T_{g} of about 95° C.; atactic polymethylmethacrylate, which has a T_{g} of about 105° C.; and polycarbonate, which has a T_{g} of about 145° C.

In some embodiments, a matrix and/or a polymer suitable for use in a coating of the present invention has a Vicat softening point (i.e., a “Vicat hardness”, which as used herein is defined as the temperature at which a material is penetrated to a depth of 1 mm by a flat-ended needle with a 1 mm² circular or square cross-section applied to the material under a load of 9.81 N) of about 50° C. to about 250° C., about 60° C. to about 250° C., about 70° C. to about 250° C., about 80° C. to about 250° C., about 90° C. to about 250° C., about 100° C. to about 250° C., about 115° C. to about 250° C., about 130° C. to about 250° C., about 145° C. to about 250° C., about 160° C. to about 250° C., about 50° C. to about 250° C., about 50° C. to about 230° C., about 50° C. to about 210° C., about 50° C. to about 190° C., or about 50° C. to about 170° C.

As used herein, a “particulate” refers to a composition of discrete particles.

As used herein, the term “particle size” refers to particle diameter. Particle size and particle size distribution can be measured using, for example, a Hyac/Royco particle size analyzer, a Malvern particle size analyzer, a Beckman Coulter laser diffraction particle size analyzer, a Shimadzu laser diffraction particle size analyzer, or any other particle size measurement apparatus or technique known to persons of ordinary skill in the art. As used herein, the term “particle diameter” relates to a volumetric measurement based on an approximate spherical shape of a particle. However, particulates for use with the present invention are not limited to primarily spherical particulate materials, but can have any three-dimensional shape such as, but not limited to, semi-spherical, ellipsoidal, cylindrical, conical, polyhedral, and toroidal shapes, and combinations thereof. For a non-spherical particulate, the mean diameter is equivalent to the longest axis of the three-dimensional particulate.

In some embodiments, a particulate for use with the present invention has a mean diameter (i.e., a particle size D₅₀) of about 100 nm to about 100 μm. In some embodiments, a particulate has a maximum mean diameter of about 100 μm, about 90 μm, about 80 μm, about 70 μm, about 60 μm, about 50 μm, about 40 μm, about 30 μm, about 25 μm, about 20 μm, about 18 μm, about 15 μm, about 12 μm, about 10 μm, about 8 μm, about 5 μm, about 2 μm, about 1 μm, about 900 nm, about 800 nm, about 700 nm, or about 600 nm. In some embodiments, a particulate has a minimum mean diameter of about 100 nm, about 150 nm, about 200 nm, about 250 nm, about 300 nm, about 350 nm, about 400 nm, about 500 nm, about 1 μm, or about 2 μm.

As used herein, a “loading” refers to the volume of a film occupied by a particulate. In some embodiments, a film of the present invention has a particulate loading of about 20% to about 95%. In some embodiments, a composite coating of the present invention has a maximum particulate loading of about 95%, about 92%, about 90%, about 88%, about 85%, about 82%, about 80%, about 78%, about 75%, about 70%, or about 65%. In some embodiments, a composite coating of the present invention has a minimum particulate loading of about 20%, about 25%, about 30%, about 35%, about 40%, about 45%, about 50%, about 55%, about 60%, about 65%, about 70%, or about 75%.

As used herein, “polydispersity index” refers to a measure of the variability or distribution of particle size in a particulate for use with the present invention. The polydispersity index, PI, is given by equation (2):

$$P I = \frac{{D}_{90} - {D}_{10}}{{D}_{50}} \qquad ( 2 )$$

wherein D₉₀ refers to a particle diameter of which about 90% of all measurable particles have a diameter equal to or less than the value D₉₀, and 10% of the measurable particles have a diameter greater than the value of D₉₀; wherein D₁₀ refers to a particle diameter of which about 10% of all measurable particles have a diameter equal to or less than the value D₁₀, and 90% of the measurable particles have a diameter greater than the value of D₁₀; and wherein D₅₀ refers to a particle diameter of which about 50% of all measurable particles have a diameter equal to or less than the value D₅₀, and 50% of the measurable particles have a diameter greater than the value of D₅₀.

In some embodiments, a particulate suitable for use with the present invention has a polydispersity index of about 1 to about 20. In some embodiments, a particulate suitable for use with the present invention has a minimum polydispersity index of about 1, about 1.1, about 1.2, about 1.3, about 1.4, about 1.5, about 1.6, about 1.7, about 1.8, about 1.9, about 2, about 2.5, about 3, about 4, about 5, about 8, or about 10. In some embodiments, a particulate suitable for use with the present invention has a maximum polydispersity index of about 20, about 18, about 16, about 15, about 12, or about 11.

Not being bound by any particular theory, having a polydispersity index of about 1 to about 20 can prevent crystallization of the particulate within the matrix, which can give rise to unwanted optical effects such as diffraction, selective reflection and/or transmission, and the like.

In some embodiments, the particulate has a D₅₀ of about 150 nm to about 50 μm. In some embodiments, the particulate has a minimum D₅₀ of about 150 nm, about 200 nm, about 250 nm, about 300 nm, about 350 nm, about 400 nm, about 500 nm, about 1 μm, about 2 μm, about 5 μm, or about 10 μm. In some embodiments, the particulate has a maximum D₅₀ of about 50 μm, about 40 μm, about 30 μm, about 25 μm, about 20 μm, about 15 μm, about 10 μm, about 8 μm, about 7 μm, about 5 μm, about 4 μm, about 3 μm, or about 2 μm.

In some embodiments, the particulate has a D₉₀ of about 1 μm to about 90 μm. In some embodiments, the particulate has a minimum D₉₀ of about 1 μm, about 2 μm, about 3 μm, about 4 μm, about 5 μm, about 7 μm, about 8 μm or about 10 μm. In some embodiments, the particulate has a maximum D₉₀ of about 90 μm, about 80 μm, about 70 μm, about 60 μm, about 50 μm, about 40 μm, about 30 μm, about 25 μm, about 20 μm, about 18 μm, about 15 μm, about 12 μm, about 11 μm, or about 10 μm.

In some embodiments, the particulate has a D₁₀ of about 120 nm to about 5 μm.

In some embodiments, the particulate has a minimum D₁₀ of about 120 nm, about 150 nm, about 200 nm, about 250 nm, about 300 nm, about 400 nm, about 500 nm, about 750 nm, about 900 nm, about 1 μm, about 2 μm, about 3 μm, about 4 μm, or about 5 μm.

In some embodiments, the particulate has a maximum D₁₀ of about 5 μm, about 4 μm, about 3 μm, about 2 μm, about 1 μm, about 900 nm, about 800 nm, or about 700 nm.

In some embodiments, the particulate has a refractive index np, that is about ±20%, ±15%, ±10%, about ±8%, about ±5%, about ±3%, about ±2%, or about equal to, the refractive index of the matrix, nm.

Not being bound by any particular theory, providing a composite coating in which n_{M} and n_{P} are within about 20% of each other can enhance the transparency and applicability of the smudge-resistant coatings to a broad range of substrates and articles of manufacture that rely upon the transmission of visible, ultraviolet and/or infrared light through a substrate, viewer, pane, window, display, and the like.

In some embodiments n_{M} and/or n_{P} can be selected to optimize the output of light through the smudge-resistant coating (i.e., maximize brightness and/or provide a wide viewing angle), and/or minimize the reflection of ambient light off of the smudge-resistant film (i.e., minimize glare). For example, in some embodiments a composite coating contains a higher concentration of a particulate at or near an outer surface of the matrix, in which case a particulate having a refractive index less than that of the matrix (i.e., n_{P}<n_{M}) can increase output coupling of light from the film and decrease reflection of ambient light from the surface of the film.

In some embodiments, a coating of the present invention comprises a particulate at least partially embedded in a matrix, wherein the particulate is present within the matrix in a concentration gradient having a highest concentration at an exterior surface of the matrix. As used herein, a “concentration gradient” refers to a variation in the percentage volume of a composite coating that is occupied by a particulate. Not being bound by any particular theory, a concentration gradient can be measured by examining a cross-sectional sample of a composite coating and averaging the unit volume that is occupied by a particulate as a function of depth from an exterior surface.

In some embodiments, a particulate has a refractive index that is less than a refractive index of the matrix. In some embodiments, a particulate has a refractive index of about 1.3 to about 1.6, about 1.32 to about 1.55, about 1.35 to about 1.55, or about 1.4 to about 1.5. Non-limiting exemplary particulate materials having a hardness and/or Young's modulus that is greater than a polymeric matrix material and a refractive index of about 1.5 or less, or about 1.45 or less, include fluorinated silicate glass (comprising Si—F bonds), organofluorinated silicate glass (comprising Si—F and/or C—F bonds), organosilicate glass (comprising Si—CH₃ bonds and/or Si—CH₂—Si bonds), and the like.

Not being bound by any particular theory, the refractive index of smudges is typically different than that of a film material. Thus, in addition to any light-blocking debris present in the smudge, this difference in refractive index between the smudge and the underlying substrate is what makes the smudge visible to a viewer, and can give a smudge an “oily” appearance, especially when deposited onto a smooth surface. However, a roughened surface both diffracts and diffuses light emerging and/or reflecting from the surface. Thus, a smudge deposited onto a roughened surface will induce less of a change in the pattern of light emerging and/or reflected from the roughened surface. Moreover, a roughened surface presents peaks and valleys (that can be in a regular pattern or in a random arrangement upon the surface) that can sequester a smudge material, such that a smudge deposited on a surface does not lead to a conformal deposition of smudge residue upon the surface. For example, the valleys of a roughened surface can remain comparably “smudge free”, whereas the peaks of a roughened surface can sequester the smudge material. Alternatively, the peaks of a roughened surface can remain comparably “smudge free”, whereas the valleys of a roughened surface can sequester the smudge material.

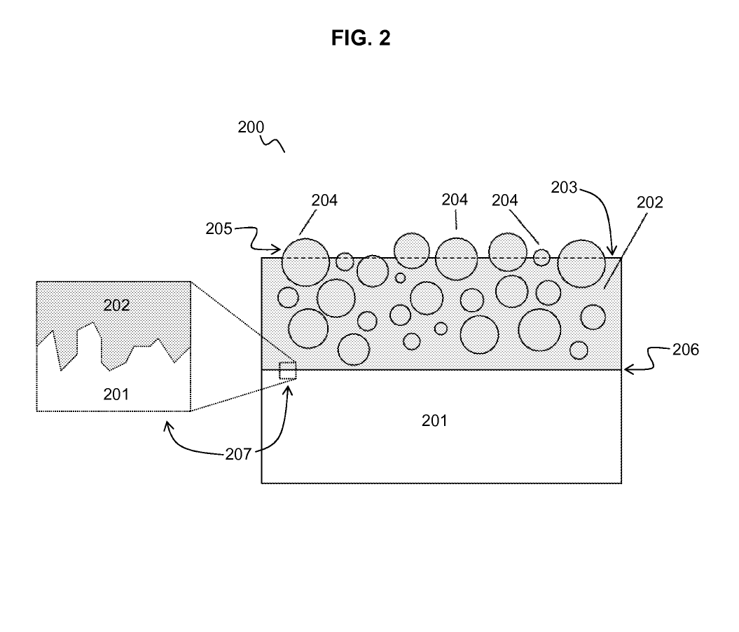

FIG. 2 provides a schematic representation of a composite smudge-resistant film.

Referring to FIG. 2, an article, 200, comprising a substrate, 201, on which is formed a matrix, 202, having a surface, 203. The matrix contains a particulate, 204. The particulate can have a monodisperse or a polydisperse particle size distribution. In some embodiments, at least a portion of the particles protrudes, 205, from the surface of the matrix. In some embodiments, the particulate concentration near the surface of the matrix, 203, and the particulate concentration at the interface between the matrix and the substrate, 206, is different. For example, as shown in FIG. 2, the particulate concentration near the matrix surface, 203, is greater than the particulate concentration at the matrix-substrate interface, 206. Additionally shown in FIG. 2 is the use of a polydisperse particulate. A polydisperse particulate can enable higher loadings of particulate to be employed compared to a monodisperse particulate. In some embodiments, the matrix-substrate interface can be roughened to enhance the outcoupling of light from a light emitting article. A magnified view of the matrix substrate interface is provided, 207, which shows that the substrate, 201, can form a roughened interface with the matrix, 202. For example, the substrate can be roughed prior to depositing the matrix, and/or the matrix deposition method can roughen the substrate in situ during the depositing.

In some embodiments, the composite coatings of the present invention can be used as an outer surface of a display without applying an additional coating to the surface of the films. For example, in some embodiments there is no additional hard coating or anti-static coating applied to the film surface.

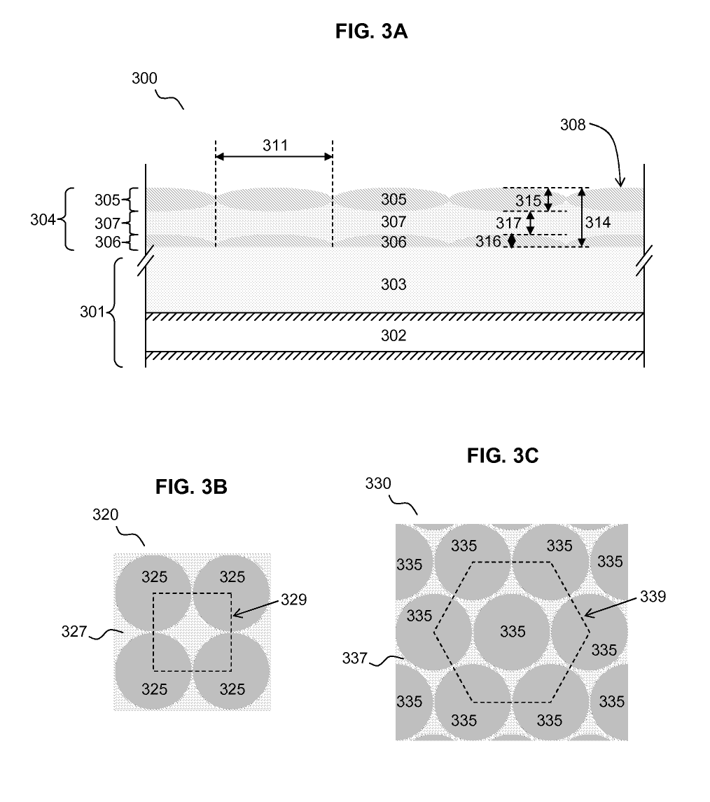

FIG. 3 provides a cross-sectional representation, 300, of a distortion-free, smudge-resistant film of the present invention. Referring to FIG. 3, a composite substrate, 301, comprising a first layer, 302, and a second layer, 303, is provided. In some embodiments, a composite substrate comprises an insulator, a semiconductor, a conductor, or a combination thereof, 302, having a transparent conductor, 303, thereon. On the composite substrate is a smudge-resistant film of the present invention, 304, comprising an array of optical elements, 305, 306 and 307, having an infinite focal length. In an exemplary embodiment, the optical elements comprise a single convex lens, 306, a double convex lens, 305, and a double concave lens, 307, there between. An optical element having an infinite focal length includes, but is not limited to, an arrangement of lenses, an arrangement of compound lenses, a Galilean telescope, an arrangement of prisms, a sawtooth grating, a square-wave grating, a sigmoidal grating, an array of trigonal pyramids, an array of square pyramids, and the like, and combinations thereof.

Referring to FIG. 3, in some embodiments, the optical elements 305, 306 and 307, are refractive index matched (i.e., have the same refractive index), or have a refractive index within about 20% of each other.

In some embodiments, the optical elements substantially lack a void space between a surface of a substrate and the roughened surface of the smudge-resistant coating. A void space in an optical coating refers to a space in the coating where a gas (e.g., air), a liquid, a vacuum, and the like can be present within the coating and/or between the distortion-free optical coating and a substrate. Not being bound by any particular theory, the distortion free-optical coating of the present invention reduces distortion by controlling light distortion using optical elements that are, in some embodiments, refractive index matched, focal length matched, and combinations thereof. The distortion-free coatings are also typically solids that provide robust smudge- and/or abrasion-resistance. Thus, the presence of a gas, liquid or vacuum within the coatings comprising an array of optical elements can lead to considerable refractive index mismatch between the layers of the optical coating. This can be contrasted with another embodiment of the present invention, in which an array of hollow, pointed elements are provided on the substrate, wherein the elements specifically comprise void space to prevent optical distortion.

Referring to FIG. 3, the smudge-resistant coating has a thickness, 314. The thickness of the coating is a sum of the thicknesses of the individual elements, 315, 316 and 317, respectively. The surface of the coating, 308, has a rms surface roughness of about 1 μm to about 100 μm, as described above.

Referring to FIG. 3, the optical elements have a lateral dimension measured parallel to the substrate, 311, of about 5 μm to about 200 μm, about 10 μm to about 200 μm, about 25 μm to about 200 μm, about 50 μm to about 200 μm, about 75 μm to about 200 μm, about 100 μm to about 200 μm, about 10 μm to about 150 μm, about 25 μm to about 150 μm, about 50 μm to about 150 μm, about 75 μm to about 150 μm, about 100 μm to about 150 μm, about 25 μm to about 125 μm, about 50 μm to about 125 μm, about 25 μm to about 100 μm, about 50 μm to about 100 μm, about 10 μm, about 25 μm, about 50 μm, about 100 μm, about 150 μm, or about 200 μm.

In some embodiments, the optical elements, 305, 306 and 307, respectively, are aligned. As used herein, “aligned” refers to optical alignment wherein the edges of the optical elements in adjacent layers of optical array are in vertical alignment with one another. Referring to FIG. 3A, the double vectors, 318, indicates that the edges of the optical elements, 305, 306, and 307, respectively, can be defined laterally by a vector oriented orthogonal to the substrate. Whereas the vector 318, is orthogonal to the plane of the substrate, 301, orthogonality is not a key feature of optical alignment, particularly for curved and/or non-planar substrates.

Nor does optical alignment require that an array of optical elements be arranged in a close-packed or densely packed arrangement on a substrate. As viewed from above, an array of aligned and/or unaligned optical elements can be arranged randomly, in a tetrahedral arrangement, in a hexagonal close packed arrangement, and other geometric arrangements, and combinations thereof. Referring to FIG. 3B, a top-view representation, 320, of a distortion-free, smudge-resistant film, is provided, the film comprising an array of optical elements, 325, in a cubic arrangement, 329. The surface of the coating adjacent to, and between, the optical elements comprises an optional filler material, 327.

Referring to FIG. 3C, a top-view representation, 330, of a distortion-free, smudge-resistant film, is provided, the film comprising an array of optical elements, 335, in a hexagonal close packed arrangement, 339. The surface of the coating adjacent to, and between, the optical elements comprises an optional filler material, 337.

While the top-view representations of FIGS. 3B and 3C depict the optical elements as having a circular footprint, the present invention can include optical elements having, without limitation, an ellipsoidal footprint, a crescent footprint, an irregular footprint, a triangular footprint, a tetragonal footprint, a square footprint, a rectangular footprint, a pentagonal footprint, a hexagonal footprint, an octagonal footprint, a star-shaped footprint, a polygonal footprint, and combinations thereof.

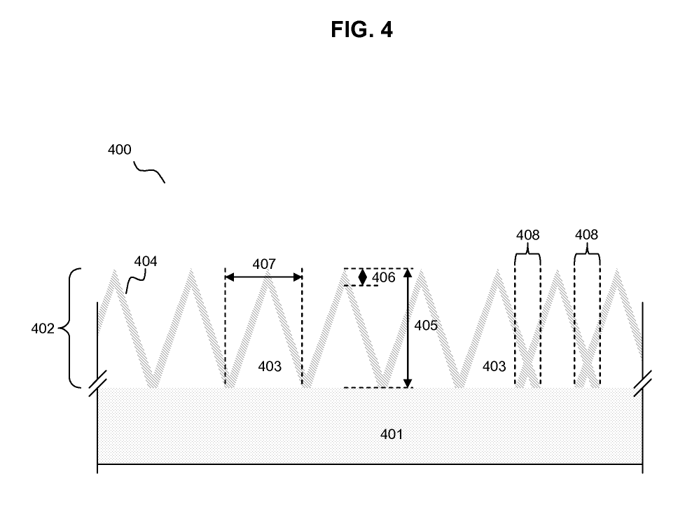

FIG. 4 provides a cross-sectional representation, 400, of a distortion-free, smudge-resistant film of the present invention. Referring to FIG. 4, a substrate, 401, that is transparent to visible light is provided, having thereon an array, 402, of hollow, 403, pointed elements, 404. The elements have a height, 405, of about 1 μm to about 300 μm, about 1 μm to about 250 μm, about 1 μm to about 200 μm, about 1 μm to about 200 μm, about 1 μm to about 150 μm, about 1 μm to about 100 μm, about 1 μm to about 50 μm, about 1 μm to about 25 μm, about 10 μm to about 300 μm, about 10 μm to about 250 μm, about 10 μm to about 200 μm, about 10 μm to about 150 μm, about 10 μm to about 100 μm, about 10 μm to about 75 μm, about 50 μm to about 300 μm, about 50 μm to about 200 μm, about 75 μm to about 300 μm, about 100 μm to about 300 μm, about 5 μm, about 10 μm, about 25 μm, about 50 μm, about 100 μm, about 150 μm, or about 200 μm. The hollow elements, 404, have a thickness, 406, that is not more than 30% of the height of the elements, 405. Thus, in some embodiments the elements have a thickness, 406, of about of about 100 nm to about 100 μm, about 200 nm to about 75 μm, about 300 nm to about 50 μm, about 400 nm to about 40 μm, about 500 nm to about 30 μm, about 750 nm to about 25 μm, about 900 nm to about 20 μm, about 1 μm to about 15 μm, about 1 μm to about 10 μm, about 5 μm to about 50 μm, about 10 μm to about 100 μm, about 1 μm, about 5 μm, about 10 μm, about 15 μm, or about 20 μm.

The hollow, pointed elements, 404, do not substantially overlap, 408, and have a width, 407. Not being bound by any particular theory, regions of substantial overlap, as depicted schematically in FIG. 4, can diminish the optical performance of the hollow coatings of the present invention. For example, regions of substantial overlap between optical elements can cause increased diffraction and optical distortion.

Suitable shapes for the hollow, pointed elements, include without limitation, cones, trigonal pyramids, tetragonal pyramids, pentagonal pyramids, hexagonal pyramids, octagonal pyramids, grooves (i.e., rows), and the like, and combinations thereof. The hollow, pointed elements can be repeated across the substrate to form an array or a pattern, such as, a hexagonal close packed pattern, a cubic pattern, or a random arrangement.

Referring to FIG. 4, the hollow, pointed elements, 404, comprise a material having a controlled refractive index. In some embodiments, the refractive index of material, 404, is less than a refractive index of the substrate, 401. In some embodiments, the refractive index of material, 404, is within about ±20% of a refractive index of the substrate, 401. In some embodiments, the refractive index of material, 404, is about 3 or less.

### Methods to Prepare the Smudge-Resistant Coatings

The present invention is directed to a method for preparing a smudge-resistant, composite coating, the method comprising:
depositing a particulate and a matrix to provide an intermediate film; and
curing the intermediate film to provide a smudge-resistant, composite coating,
   wherein the curing embeds the particulate at least partially in the matrix to provide a smudge-resistant, composite coating having a concentration gradient of the particulate that is greatest at the exterior surface of the matrix, and wherein the composite coating has a root mean square surface roughness of about 100 nm to about 10 μm.

The matrix can be, without limitation, a liquid, a solution, a suspension, a gel (or any other viscous liquid), a colloid, a solid, a solid solution, a particulate, and combinations thereof.

In some embodiments, the matrix comprises a liquid or gel having a viscosity of about 10 centiPoise (“cP”) to about 1,000 cP, about 20 cP to about 1,000 cP, about 50 cP to about 1,000 cP, about 100 cP to about 1,000 cP, about 500 cP to about 1,000 cP, about 10 cP to about 500 cP, about 20 cP to about 200 cP, about 50 cP to about 150 cP, about 10 cP, about 20 cP, about 50 cP, or about 100 cP.

In some embodiments, the matrix comprises a solvent. In some embodiments, the matrix comprises a volatile solvent having a vapor pressure at 25° C. of about 20 mm Hg or less. In some embodiments, the matrix comprises a solvent having a boiling point of about 100° C. or less at a pressure of 760 mm Hg. Solvents suitable for use with a matrix of the present invention include aromatics (e.g., benzene, toluene, xylene, and the like), alcohols (e.g., methanol, ethanol, propanol, and the like), ketones (e.g., acetone, methylethylketone, and the like), amides (e.g., N,N-dimethylformamide, N,N-dimethylacetamide, and the like), halogenated alkanes (e.g., methylene chloride, chloroform, 1,1-dichloroethylene, 1,2-dichloroethylene, and the like), glycols (ethylene glycol, and the like), esters (ethyl acetate, and the like), and any other solvents known to persons of ordinary skill in the art.

In some embodiments, the method further comprises depositing a particulate and a matrix onto a substrate. The substrate can be, e.g., an optical surface in need of smudge- and/or abrasion-protection. In some embodiments, the depositing and/or the curing can adhere the composite coating to the substrate. Alternatively, a substrate can comprise a sacrificial substrate from the composite coating is subsequently removed. For example, a composite coating can be prepared on a hydrophobic substrate, such as a fluorinated glass, removed therefrom, and an adhesive can be applied to a backside or underside of the composite coating (i.e., the surface of the composite coating that was in contact with the sacrificial substrate) and the composite coating can be permanently or reversibly adhered to an optical substrate in need of protection from smudges, abrasions, and the like.

In some embodiments, the method comprises depositing a particulate onto a surface of the matrix to provide an intermediate film. Thus, in some embodiments, the method comprises depositing a matrix and depositing a particulate onto the matrix to provide an intermediate film.

The curing embeds the particulate at least partially in the matrix. For example, in some embodiments curing comprises hardening the matrix, removing a solvent from the matrix, cross-linking the matrix, reacting the matrix, and combinations thereof.

Generally, the curing solidifies the matrix such that the particulate becomes rigidly fixed within and protruding from the matrix.

In some embodiments, curing comprises heating the intermediate film above a glass transition temperature of the matrix, or about the Vicat softening temperature of the matrix to embed the particulate at least partially in the matrix. In some embodiments, the curing further bonds the particulate to the matrix and embeds the particulate in the matrix to provide a smudge-resistant, composite coating having a concentration gradient of the particulate that is greatest at the exterior surface of the matrix, and wherein the film has a root mean square surface roughness of about 100 nm to about 10 μm.

In some embodiments, the particulate is deformed during the curing of the intermediate film. As used herein, “deform” refers to modifying the three-dimensional shape, the volume, the density, the chemical functional groups attached to a surface, or a combination thereof, of a particulate. Therefore, in addition to, for example, heating a particulate to melt or physically modify its three-dimensional shape, deforming can include increasing or decreasing the volume and/or density of a particulate, for example, by removing a solvent therefrom, or adding a solvent thereto; chemically derivatizing the surface of a particulate; manipulating the composition of a particulate; increasing or decreasing the propensity of a particulate to aggregate, for example, by applying a static charge to the particulate; and combinations thereof.

In some embodiments, a cured particulate has a D₅₀ of about 200 nm to about 50 μm, about 200 nm to about 40 μm, about 200 nm to about 25 μm, about 200 nm to about 20 μm, about 200 nm to about 15 μm, about 200 nm to about 10 μm, about 200 nm to about 5 μm, about 200 nm to about 2 μm, about 200 nm to about 1 μm, about 200 nm to about 750 nm, about 200 nm to about 500 nm, about 500 nm to about 50 μm, about 500 nm to about 25 μm, about 500 nm to about 20 μm, about 500 nm to about 15 μm, about 500 nm to about 10 μm, about 500 nm to about 5 μm, about 1 μm to about 50 μm, about 2 μm to about 50 μm, about 5 μm to about 50 μm, about 10 μm to about 50 μm, about 1 μm, about 2 μm, about 5 μm, about 10 μm, about 25 μm, or about 50 μm.

In some embodiments, the method further comprises hardening the matrix. As used herein, “hardening” refers to increasing the mechanical strength (e.g., Young's modulus, hardness, and the like) of a matrix. Non-limiting examples of hardening processes include: cooling, exposing to thermal energy, exposing to electromagnetic radiation (e.g., ultraviolet light, visible light, infrared light, microwave light, etc.), removing a solvent from, cross-linking, reacting with a substrate, and combinations thereof.

In some embodiments, curing the intermediate film and hardening the matrix are performed simultaneously. In some embodiments, curing the intermediate film and hardening the matrix are performed simultaneously and are performed using the same energy source and/or chemical reagent.

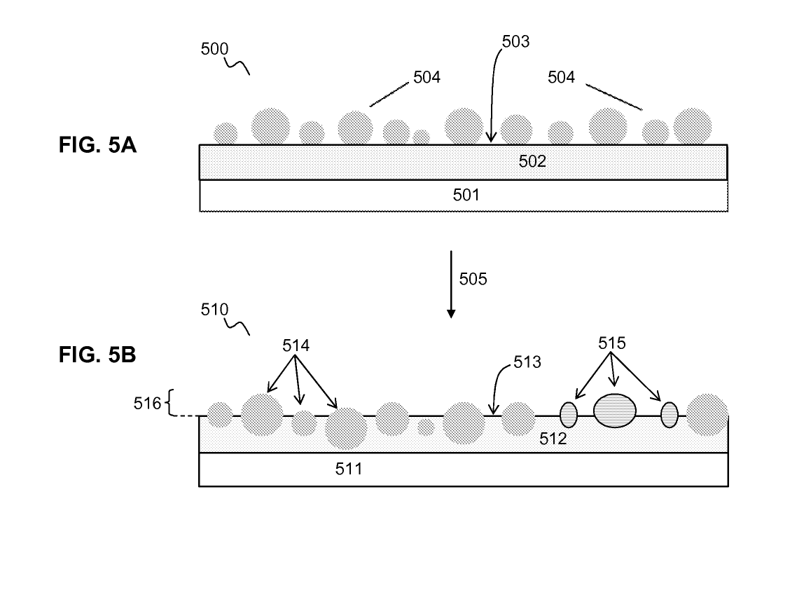

FIGS. 5A and 5B provide a schematic cross-sectional representation of a method for preparing a composite smudge-resistant coating of the present invention. Referring to FIG. 5A, a cross-sectional representation, 500, of an intermediate film is provided, the intermediate film comprising a substrate, 501, a matrix, 502, and an exterior surface of the matrix, 503. A particulate, 504, has been deposited on the surface of the matrix, 503. The particulate can be monodisperse or polydisperse. The intermediate film is then cured, 505.

Referring to FIG. 5B, a cross-sectional representation, 510, of a composite, smudge-resistant coating is provided. The coating is adhered to a substrate, 511, comprising a matrix thereon, 512, having a particulate, 514, at least partially embedded therein. At least a portion of the particulate protrudes, 516, from an exterior surface of the matrix, 513. In some embodiments, the particulate has been deformed, 515, by the curing. For example, polystyrene and/or polyurethane particulates can be deformed by heating to change their shape and embed the modified particulate at least partially in a matrix. In some embodiments, the method further comprises hardening the matrix, 512.

In some embodiments, a particulate is deposited onto a substrate and a matrix-forming precursor is applied to the substrate and then reacted to embed the particulate in the matrix.

In some embodiments, a substrate can be functionalized, derivatized, textured, or otherwise pre-treated prior to depositing a smudge-resistant coating of the present invention. As used herein, “pre-treating” refers to chemically or physically modifying a substrate prior to applying or deposition. Pre-treating can include, but is not limited to, cleaning, oxidizing, reducing, derivatizing, functionalizing, exposing a surface to a reactive gas, plasma, thermal energy, ultraviolet radiation, and combinations thereof. Not being bound by any particular theory, pre-treating a substrate can increase or decrease an adhesive interaction between two layers.

In some embodiments, after deposition of one or more layers, a substrate and/or a smudge-resistant film deposited thereon can be post-treated. Post-treatment can sinter, cross-link, or cure a substrate, a layer of a film, as well as, increase adhesion (e.g., substrate-to-film and/or inter-layer), increase density, and the like.

In some embodiments, a smudge-resistant film is deposited in a conformal manner. As used herein, “conformal” refers to a layer or coating that is of substantially uniform thickness regardless of the geometry of underlying features. Thus, conformal coating of protrusions of various size and shape can result in smudge-resistant films having substantially similar sizes and shapes, and the size of the resulting articles can be controlled by selecting the dimensions of a substrate (e.g., the spacing and dimensions of a grating, or shape of a touch-screen, and the like). Conformal deposition methods include, but are not limited to, chemical vapor deposition, spin-coating, casting from solution, dip-coating, atomic layer deposition, self-assembly, and combinations thereof, as well as any other deposition methods that would be apparent to a person of ordinary skill in the art of conformal film deposition.

The present invention is directed to a method for preparing a smudge-resistant film, the method comprising:
depositing a matrix onto a substrate; and
exposing the substrate to an abrasive to produce the smudge-resistant film,
wherein the film has a root mean square surface roughness of about 100 nm to about 10 μm.

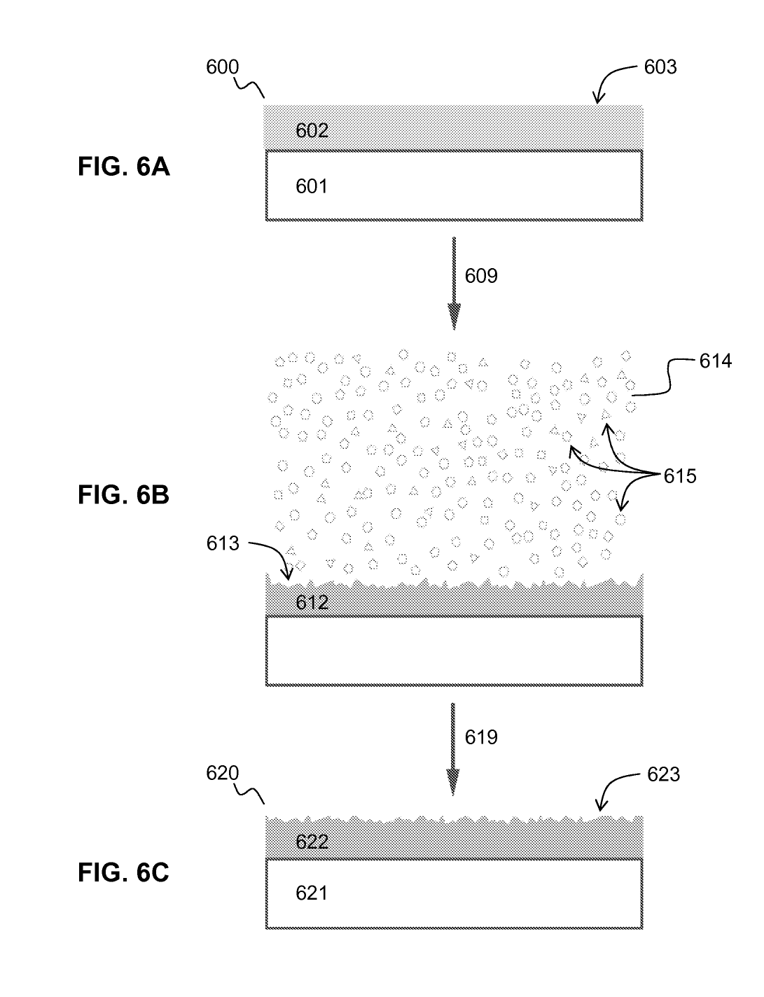

FIGS. 6A-6C provide a schematic cross-sectional representation of a method for preparing a roughened substrate and/or roughened film of the present invention. Referring to FIG. 6A, an article, 600, comprising a substrate, 601, having a film deposited thereon, 602, is provided. The film has an outer surface, 603. The outer surface of the film is roughened, 609, by placing the outer surface of the film in contact with a composition, 614, comprising an abrasive component, 615, as shown in FIG. 6B. In some embodiments, the film, 612, is roughened by removing material from the film. Alternatively, the surface can be roughened by depositing material onto the film. The substrate and film and the abrasive composition are then separated, 619. Referring to FIG. 6C, an article, 620, is prepared having a roughened surface, 623. In this embodiment the roughened surface, 623, is a surface of a film, 622, that coats a substrate. However, the roughened surface can also be on the substrate itself, 621, or at least a portion thereof.

The present invention is also directed to a method for preparing a distortion-free, smudge-resistant optical coating, the method comprising forming on a substrate a layer comprising an array of optical elements, wherein the substrate and the layer are transparent to visible light, wherein the optical elements have an infinite focal length, the optical elements have a lateral dimension, measured parallel to the substrate, of about 5 μm to about 200 μm, and the layer has an exterior surface having a root mean square surface roughness of about 1 μm to about 100 μm.

In some embodiments, an array of compounds lenses having an infinite focal length comprises two or more layers of optical elements, three or more layers of optical elements, four or more layers of optical elements, or more than four layers of optical elements.

In some embodiments, a layer comprising an array of optical elements has a refractive index that is less than a refractive index of a substrate.

In some embodiments, the method further comprises patterning the substrate to form an optical surface thereon that is complementary to the exterior surface of an array of optical elements. Patterning of a substrate can be achieved by traditional lithographic methods (i.e., conformal photoresist deposition followed by photolithography, developing, and etching), hot embossing, microcontact printing of a resist followed by etching, microcontact printing of a resist of a self-assemble monolayer followed by amplification and etching, direct microtransfer molding of an optical pattern, microtransfer molding of a resist followed by etching, micromolding in capillaries, and the like, and combinations thereof.

In some embodiments, an array of optical elements further comprises one or more layers that is optically inert (i.e., the three dimensional shape of the layer does not focus or diverge light). Not being bound by any particular theory, an inert layer can be used to fill a gap between a first layer of optical elements and a second layer of optical elements in a multi-layer coating of the present invention. Materials suitable for use as filler materials include, glasses, dielectrics, polymers, plastics, and the like, in particular those polymers and matrix materials described elsewhere herein.

In some embodiments, an optically inert material is selected based upon its refractive index. In some embodiments, an optically inert layer has a refractive index of about 1.1 to about 2.2, about 1.2 to about 2.2, about 1.3 to about 2.2, about 1.4 to about 2.2, or about 1.4 to about 2.0. In some embodiments, an optically inert material has a refractive index within about 20% of the refractive index of a layer of optical elements, or a refractive index that is about equal to a layer of optical elements.

In some embodiments, the forming comprises:
depositing a first layer of a first material on the substrate, wherein the first layer includes a surface having a first three-dimensional pattern thereon;
depositing a second layer of a second material on the first layer, wherein the second material includes a surface having a second three-dimensional pattern thereon;
depositing a third layer of a third material on the second layer, wherein the third layer includes a surface having a third three-dimensional pattern thereon,
   wherein the first, second and third three-dimensional patterns are optically aligned to provide an array of optical elements having an infinite focal length, and wherein the first, second and third materials are transparent to visible light.

An optical element having an infinite focal length can comprise multiple (i.e., two or more) layers. For example, an optical element having an infinite focal length can comprise one, two, three, four, five, or more layers of material. The individual layers of which the array of optical elements is comprised can be the same or different, and likewise have a refractive index that is the same or different. In some embodiments, an array of optical elements comprises two or more layers, the layers of the array comprising optical elements of different focal lengths. Alternatively, the optical elements of different layers of the array can have the same focal length.

In some embodiments, the forming comprises applying a moldable precursor to the substrate, contacting an elastomeric stamp having a surface including a three dimensional pattern therein with the moldable precursor, and hardening the moldable precursor to form an array of optical elements corresponding to the three dimensional pattern in the surface of the elastomeric stamp.

In some embodiments, the forming comprises applying a moldable precursor to an elastomeric stamp having a surface including a three dimensional pattern therein, and contacting the coated elastomeric stamp with a substrate to transfer the moldable precursor to the substrate to form an array of optical elements corresponding to the three dimensional pattern in the surface of the elastomeric stamp. The moldable precursor can be hardened before or after removing the elastomeric stamp from the substrate.

As used herein, an elastomeric stamp refers to a molded, three-dimensional object comprising an elastomeric polymer. Elastomeric polymers suitable for use with the present invention include, but are not limited to, polydimethylsiloxane, polysilsesquioxane, polyisoprene, polybutadiene, polychloroprene, acryloxy elastomers, fluorinated and perfluorinated polymers (e.g., polytetrafluoroethylene, perfluoroalkoxy polymer, fluorinate ethylene propylene, and the like), and combinations thereof. Suitable elastomers and stamps made therefrom are also disclosed in U.S. Pat. Nos. 5,900,160 and 6,355,198, each of which is incorporated herein by reference in their entirety.

In some embodiments, a moldable precursor is applied to a substrate and an array of microspheres is applied thereto. The array of microspheres is imprinted into the moldable precursor to form an array of optical elements on the substrate. The moldable precursor can be hardened while an array of microspheres is in contact with the moldable precursor or after the array of microspheres is removed. A second moldable precursor can then be applied to the first array of optical elements and subsequently patterned with a complementary three dimensional object to provide an array of optical elements having an infinite focal length.

As used herein, a “moldable precursor” refers to a compound, precursor, molecule, species, moiety, polymer, and the like capable of filling an indentation in an elastomeric stamp. In some embodiments, a moldable precursor comprises a polymer. Polymers suitable for use as moldable precursors include those polymers described herein as suitable for use as a matrix and or a coating layer of the present invention.

In some embodiments, the forming comprises molding a material with an elastomeric stamp including a surface having at least one indentation therein to provide the first and second arrays of optical elements.

The hardening of a moldable precursor can comprise any of the above hardening processes described herein. In some embodiments, the method further comprises removing the elastomeric stamp from the substrate. The hardening can be performed before or after removing an elastomeric stamp from the substrate.

In some embodiments, the method of the present invention further comprises polishing a roughened film or surface. Not being bound by any particular theory, surface roughness on the order of about 100 nm to about 100 μm can improve the smudge resistance of a film or substrate. However, a roughened surface will typically exhibit decreased optical transmission properties compared with a smooth surface of the same composition. In some embodiments, the optical transmission of a roughened surface can be improved by polishing. Roughened surfaces of the present invention can be polished by a method chosen from: chemically polishing, mechanically polishing, thermally polishing, and combinations thereof.

As used herein, “chemically polishing” refers to a method of applying a reactive composition to a surface, whereby reaction between the surface and composition reduces the frequency of sub-100 nm features on the surface. In some embodiments, a reactive composition can comprise a reagent chosen from: an acidic reagent, a basic reagent, a fluoride reagent, and combinations thereof.

Acidic reagents suitable for use with the present invention include, but are not limited to, sulfuric acid, trifluoromethanesulfonic acid, fluorosulfonic acid, trifluoroacetic acid, hydrofluoric acid, hydrochloric acid, carborane acid, and combinations thereof.

Basic reagents suitable for use with the present invention include, but are not limited to, sodium hydroxide, potassium hydroxide, ammonium hydroxide, tetraalkylammonium hydroxide ammonia, ethanolamine, ethylenediamine, and combinations thereof.

Fluoride reagents suitable for use with the present invention include, but are not limited to, elemental fluorine, ammonium fluoride, lithium fluoride, sodium fluoride, potassium fluoride, rubidium fluoride, cesium fluoride, francium fluoride, antimony fluoride, calcium fluoride, ammonium tetrafluoroborate, potassium tetrafluoroborate, and combinations thereof.

As used herein, “mechanically polishing” refers to methods chosen from: contacting a particulate composition with a surface, brushing a surface, and combinations thereof, whereby friction and/or mechanical interaction with the surface reduces the frequency of sub-100 nm features on the surface.

As used herein, “thermally polishing” refers to a method of applying thermal energy to a surface, whereby the thermal energy reduces the frequency of sub-100 nm features on the surface. In some embodiments, a thermal energy is chosen from: a convective thermal energy (e.g., heating in an oven or furnace), a conductive thermal energy (contacting the substrate or film with a heating element and the like), an electromagnetic thermal energy (e.g., infrared light), a plasma thermal energy (e.g., a plasma at about 50° C. or greater), and combinations thereof.

In some embodiments, the method of the present invention further comprises depositing a transparent protective layer onto the outward-facing surface of the smudge-resistant film such as, but not limited to, an anti-reflective coating and the like.

### Methods of Preventing the Formation of Smudges on a Surface

The present invention is also directed to methods for preventing the formation of smudges on a surface, the method comprising applying to a surface a roughened film of the present invention. In some embodiments, the method of the present invention comprises applying to a surface in need of preventing smudges thereon a layer having at least one protrusion thereon, wherein the protrusion includes a hydrophobic coating.

Surfaces in need of protection from smudges include those substrates described above.

As used herein, a “protrusion” refers to an area of a substrate that is contiguous with, and topographically distinguishable from, the areas of the substrate surrounding the protrusion. As used herein, “protrusion” is synonymous with “optical element” and “optical coating”, and can be used to generically describe the features of these embodiments.

In some embodiments a protrusion can be distinguished from the areas of the substrate surrounding the protrusion based upon the composition of the protrusion, or another property of the protrusion that differs from the surrounding areas of the substrate. In some embodiments, a protrusion can have a three-dimensional shape such as, but not limited to, a rectilinear polygon, a cylinder, a pyramid (e.g., a trigonal pyramid, square pyramid, etc.), a trapezoid, a cone, and combinations thereof. In some embodiments, a protrusion comprises a ridged feature having a profile such as, but not limited to, a sinusoidal profile, a parabolic profile, a rectilinear profile, a saw tooth profile, and combinations thereof. In those embodiments in which a substrate comprises multiple protrusions, the present invention encompasses all possible spatial arrangements of the protrusions on the substrate including symmetric, asymmetric, ordered, random spatial arrangements.

A protrusion has at least one lateral dimension. As used herein, a “lateral dimension” refers to a dimension of a protrusion that lies in the plane of a substrate. One or more lateral dimensions of a protrusion define, or can be used to define, the area of a substrate that a protrusion occupies. Typical lateral dimensions of protrusions include, but are not limited to: length, width, radius, diameter, and combinations thereof. A protrusion has at least one lateral and at least one vertical dimension.

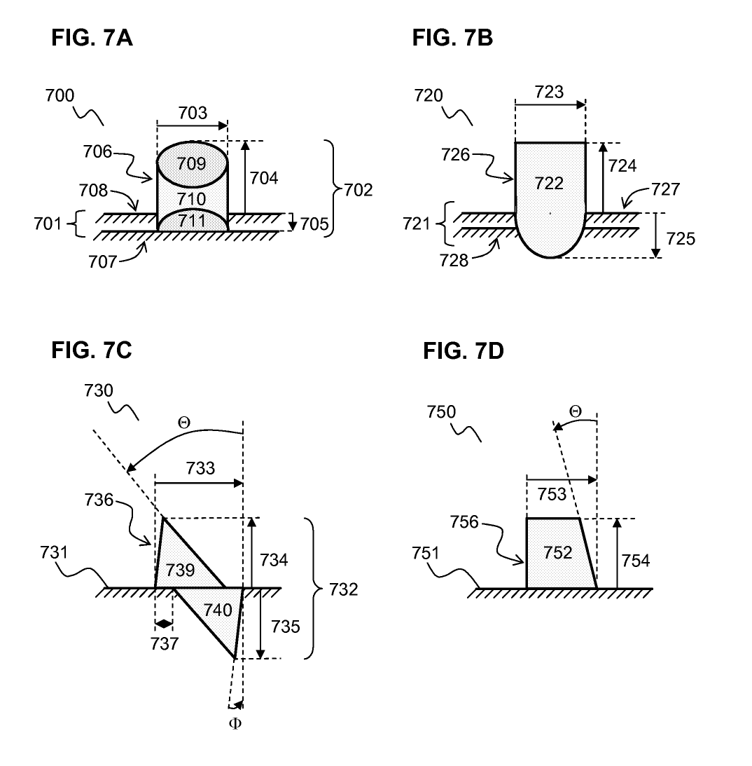

When an area of a substrate surrounding a protrusion is planar, a lateral dimension of a protrusion is the magnitude of a vector between two points located on opposite sides of the protrusion, wherein the two points are in the plane of the substrate, and wherein the vector is parallel to the plane of the substrate. In some embodiments, two points used to determine a lateral dimension of a symmetric protrusion also lie on a mirror plane of the symmetric protrusion. In some embodiments, a lateral dimension of an asymmetric protrusion can be determined by aligning the vector orthogonally to at least one edge of the protrusion. For example, in FIGS. 7A-7D the lateral dimension of the protrusions, 702, 722, 732 and 752, respectively, is indicated by the magnitude of vectors 703, 723, 733, and 753, respectively.

A vertical dimension of a protrusion is the magnitude of a vector orthogonal to the substrate between a point in the plane of the substrate and a point on the protrusion that is farthest from the substrate. For example, in FIGS. 7A-7D the vertical dimensions of the protrusions, 702, 722, 732 and 752, respectively, are indicated by the magnitude of the vectors 704, 724, 734, and 754, respectively.

In some embodiments, the base of a protrusion, or the base of an optical element of a coating of the present invention, lies below (i.e., within) the surface of a substrate. As used herein, a “penetrating protrusion” penetrates into a substrate to a depth below the surface of the substrate. The penetration distance refers to the depth to which a protrusion penetrate into the surface of a substrate. For example, in FIGS. 7A-7C, the penetration distance of protrusions 702, 722 and 732, respectively, is indicated by the magnitude of vectors 705, 725 and 735, respectively.

In some embodiments, a protrusion or an optical element present in a coating of the present invention has a sidewall. As used herein, a “sidewall” refers to any surface of a protrusion that is not substantially planar to a plane oriented parallel to the substrate. For example, in FIGS. 7A-7D protrusions 702, 722, 732 and 752 are shown having sidewalls 706, 726, 736 and 756, respectively. In those embodiments in which the sidewall of a protrusion is orthogonal to a plane oriented parallel to the substrate, a height of the sidewall can be equal to the vertical dimension of the protrusion.

Protrusions and/or coating layers of the present invention can have a composition that differs from, is the same as, or is substantially the same as, a composition of a substrate. For example, a protrusion can be formed by an additive method (e.g., deposition), a subtractive method (e.g., etching), and combinations thereof.

In some embodiments, a protrusion has an “angled” sidewall. As used herein, an “angled sidewall” refers to a sidewall that is not orthogonal to a plane oriented parallel to a substrate. A sidewall angle is thus equal to the angle formed between a vector orthogonal to a surface of a substrate that intersects an edge of a protrusion and a vector intersecting the edge of the protrusion at the same point that is parallel to the surface of the sidewall. An orthogonal sidewall has a sidewall angle of 00. For example, a sidewall angle in FIG. 7C of the protrusion 732 is shown as Θ and Φ, and a sidewall angle in FIG. 7D of the protrusion 752 is shown as Θ. While the sidewall angles depicted in FIGS. 7C and 7D are constant over the surface of the sidewalls, 736 and 756, respectively, the sidewall angle can also vary. For example, protrusions having curved, faceted and sloped sidewalls are within the scope of the present invention. In some embodiments, a protrusion includes a sidewall that is curved and/or sloped near the top and/or base of the protrusion. In some embodiments, an angled sidewall can has an “average sidewall angle”, which can be calculated by averaging an angle formed between a point on a sidewall and the substrate over the surface of the sidewall. In some embodiments, an optical element (i.e., a protrusion) formed by the methods of the present invention has a sidewall angle or an average sidewall angle of about 80° to about −50°, about 80° to about −30°, about 80° to about −10°, or about 80° to about 0°.

Not being bound by any particular theory, the sidewall angle of a protrusion can contribute to the hydrophobicity of the film. For example, a hydrophobic film of the present invention having a steep vertical sidewall ending in a point will typically be more hydrophobic than a protrusion having the same composition but a lower profile sidewall.

Referring to FIG. 7A, a cross-sectional schematic diagram, 700, of a composite substrate, 701, having a protrusion, 702, thereon is provided. A composite substrate (e.g., a laminate substrate) can comprise two or more layers of material, e.g., layers 707 and 708, respectively, that can be the same or different. The protrusion, 702, comprises a compound optical element comprising a double convex lens element, 709, a double concave lens element, 710, and a single convex lens element, 711. The optical elements, 709, 710 and 711 are vertically aligned. As described elsewhere herein, the protrusion has a lateral dimension indicated by the magnitude of vector 703, a height indicated by the magnitude of vector 704, and a penetration distance indicated by the magnitude of vector 705.

Referring to FIG. 7B, a cross-sectional schematic diagram, 720, of a composite substrate, 721, having a protrusion, 722, thereon is provided. The composite substrate comprises two layers, 727 and 728, respectively, that can be the same or different. The protrusion, 722, is a penetrating protrusion having a lateral dimension indicated by the magnitude of vector 723, a height indicated by the magnitude of vector 724, and a penetration distance indicated by the magnitude of vector 725.

Referring to FIG. 7C, a cross-sectional schematic diagram, 730, of a substrate, 731, having a protrusion, 732, thereon is provided. The protrusion, 732, comprises a compound optical element comprising a first prism, 739, and a second prism, 740. The first and second prisms are offset from one another by a distance, 737. As described elsewhere herein, the protrusion has a lateral dimension indicated by the magnitude of vector 733, a height indicated by the magnitude of vector 734, a penetration distance indicated by the magnitude of vector 735, and a sidewall angle indicated by Θ and Φ.

Referring to FIG. 7D, a cross-sectional schematic diagram, 750, of a substrate, 751, having a protrusion, 752, thereon is provided. The protrusion, 752, is an additive protrusion having a lateral dimension indicated by the magnitude of vector 753, a height indicated by the magnitude of vector 754, and a sidewall angle indicated by Θ.

A substrate is “curved” when the radius of curvature of a substrate is non-zero over a distance on the substrate of 1 mm or more, or over a distance on the substrate of 10 mm or more. For a curved substrate, a lateral dimension is defined as the magnitude of a segment of the circumference of a circle connecting two points on opposite sides of a protrusion, wherein the circle has a radius equal to the radius of curvature of the substrate. A lateral dimension of a curved substrate having multiple or undulating curvature, or waviness, can be determined by summing the magnitude of segments from multiple circles.

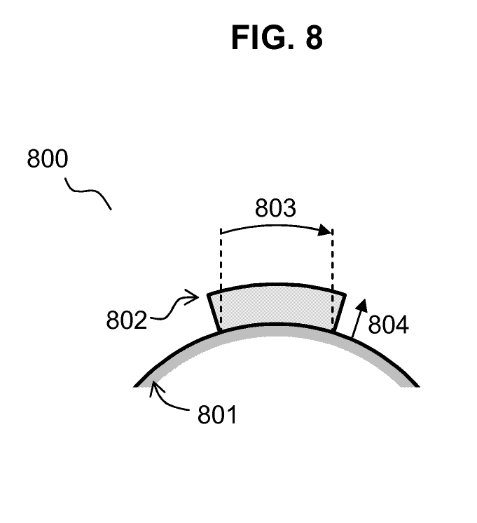

FIG. 8 provides a cross-sectional schematic representation, 600, of a curved substrate, 801, having a protrusion, 802, thereon. A lateral dimension of the protrusion, 803, is indicated by the magnitude of the vector 803. Protrusion 802 has a vertical dimension indicated by the magnitude of vector 804.

In some embodiments, a substrate having at least one protrusion thereon comprises a grating. Gratings suitable for use as films and smudge-resistant coatings of the present invention include those generally known in the optical arts, including grating fabricated by methods of contact printing, embossing, imprint lithography, standard photolithographic techniques, holographic lithography, and microcontact molding.

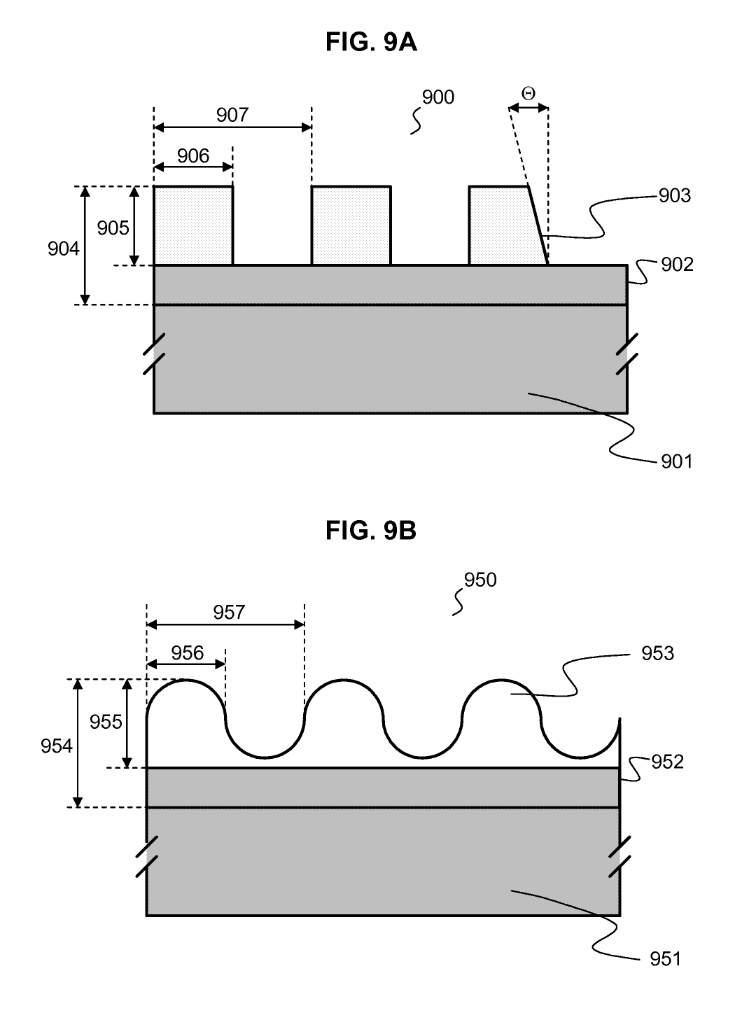

FIGS. 9A and 9B provide schematic cross-sectional representations of gratings, 900 and 950, respectively, suitable for use with the present invention. Referring to FIG. 9A, a grating for use with the present invention comprises a substrate, 901, having an optional top layer, 902, the composition of which can be the same or different, and a grating comprising a series of protrusions, 903, having a height, 905, a width, 906, and a periodicity (i.e., repeat distance), 907. In some embodiments, the repeat distance and/or width of the grating can vary across the distance of the grating. In some embodiments, the sidewalls of the grating are angled, and have a “sidewall angle” or “blaze angle,” 0, of 0° to about 80°. Gratings for use with the present invention need not have a rectilinear profile, as shown in FIG. 9A, but can have a sinusoidal profile, a parabolic profile, a rectilinear profile, a saw tooth profile, and combinations thereof. For example, FIG. 9B provides a cross-sectional schematic representation of a grating have a sinusoidal profile. The grating, 950, comprises a substrate, 951, having an optional top layer, 652, the composition of which can the same or different, and a grating made up of a series of protrusions, 953, having a sinusoidal shape and a height, 955, width, 956, and repeat distance, 957.

In some embodiments, a protrusion on a substrate has at least one lateral dimension of about 100 nm to about 20 μm, about 100 nm to about 10 μm, about 100 nm to about 1 μm, about 100 nm to about 500 nm, about 500 nm to about 20 μm, about 500 nm to about 10 μm, or about 500 nm to about 1 μm.

In some embodiments, a protrusion has an elevation of about 100 nm to about 1 mm, about 100 nm to about 500 μm, about 100 nm to about 200 μm, about 100 nm to about 100 μm, about 100 nm to about 50 μm, about 100 nm to about 10 μm, about 100 nm to about 1 μm, or about 100 nm to about 500 nm above the plane of a surface.

The substrates suitable for use with the present invention, and the smudge-resistant coatings provided thereon can be structurally and compositionally characterized using analytical methods known to those of ordinary skill in the art of thin film fabrication and characterization.

### EXAMPLES

### Hypothetical Example 1

A smudge-resistant composite coating of the present invention can be prepared by first preparing a solution of 10% by weight solution of polymethylmethacrylate (PMMA) in acetone, to which is added a polydisperse particulate mixture of colloidal silica particles. The particulate mixture is added to the solution to a loading of 10% by weight. The resulting mixture is then thoroughly mixed to the point of homogeneity. The homogeneous mixture is applied to a substrate by spin-coating. The solvent (i.e., acetone) can be removed from the resulting film by standing at room temperature for several minutes, or by heating to about 50° C. for about 30 seconds. The resulting composite coating will have a 50% loading (by weight) of colloidal silica particles.

### Hypothetical Example 2

The composite coating of Example 1 can be post-treated to roughen the surface of the film. For example, exposure of the film to an oxygen plasma for about 10 to about 30 seconds will selectively etch the PMMA matrix, thereby exposing a portion of the colloidal silica particles near the film surface.

### Hypothetical Example 3

In another embodiment, the composite coating of Example 1 will be post-treated to increase the rms surface roughness of the composite film, and optionally fluorinate an exterior surface of the film. Specifically, a composite film prepared by Example 1 will be exposed to an oxygen plasma to selectively etch the PMMA matrix and partially expose and activate the colloidal silica particles. The composite film will then be optionally exposed to a vapor comprising tridecafluoro-1,1,2,2-tetrahydrooctyltrichlorosilane to fluorinate the exterior surface of the composite film.

### Hypothetical Example 4

A smudge-resistant composite coating of the present invention can be prepared by first preparing a 5% by weight solution of polystyrene (PS) in toluene. The solution is then loaded to about 15% by weight with a polydisperse mixture of cross-linked PS beads. The resulting mixture can then be thoroughly mixed to the point of homogeneity, and then be applied to a substrate by spin-coating. The solvent (i.e., toluene) is then removed from the resulting film, for example, by heating to about 30° C. for about 2 minutes. The dry composite coating will have a 75% loading (by weight) of PS particles in a PS matrix. The composite smudge-resistant film could be used without further processing.

### Hypothetical Example 5

A smudge-resistant composite coating of the present invention can be prepared by first preparing a 0.01% by weight suspension of polydisperse PS beads in a water-ethanol solution (about 90% water and 10% ethanol, v/v) that also contains about 10 ppm Triton® X-100 surfactant (The Dow Chemical Co., Midland, Mich.). The 0.01% by weight polydisperse suspension can be drop-cast onto a substrate (e.g., glass) and allowed to dry. The resulting film can be heated for about 1 hour at about 95° C., during which time the PS beads will soften and/or partially melt and reflow, thereby forming a disordered array of polydisperse hemispheres on the substrate.

### Hypothetical Example 6

A smudge-resistant composite coating of the present invention can be prepared by first preparing a 5% by weight solution of polystyrene in toluene, and then applying the resulting mixture to a substrate (e.g., glass) by spin-coating. The solvent can then be removed, and the resulting film exposed to an abrasive mixture (i.e., a slurry) for about 5 minutes. After exposure to the abrasive mixture, the resulting film can have a textured, matte surface having an rms roughness of about 100 nm to about 100 μm.

### Example 7

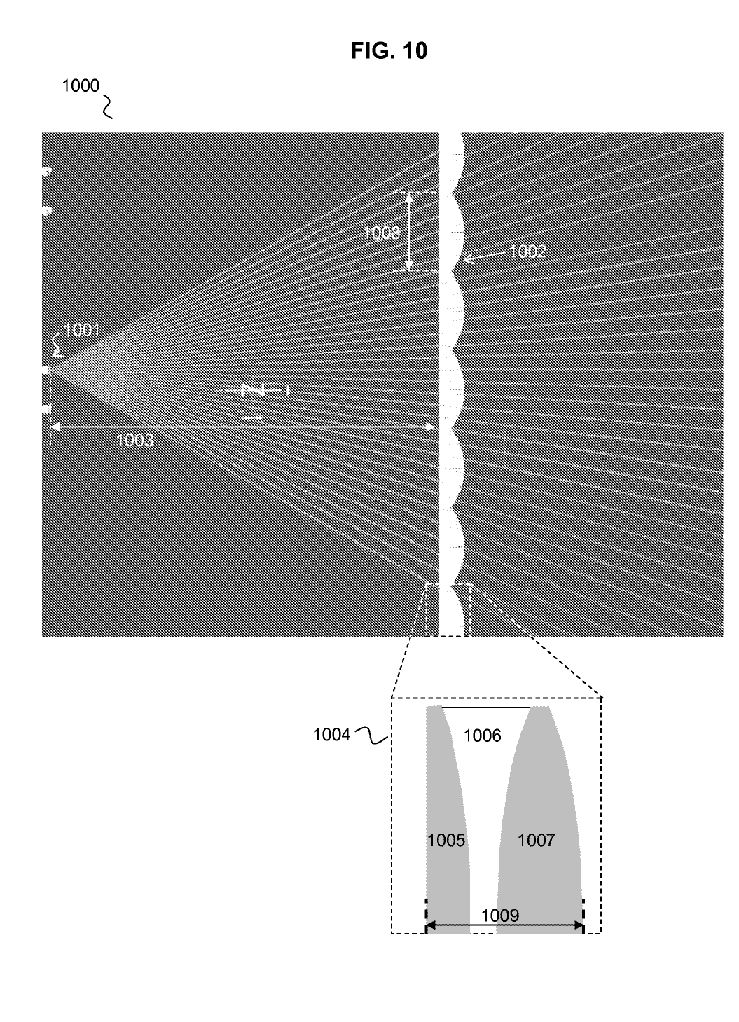

Light diffraction through a composite coating comprising optical elements of infinite focal length was simulated using Optics Lab Optical Ray Tracing Software™ (Science Lab Software, Carlsbad, Calif.). FIG. 10 provides an image, 1000, of a ray-trace diagram prepared from the simulation. A point light source, 1001 (wavelength=600 nm), was projected onto an array of compound lenses, 1002. The distance from the light source to the closest surface of the compound lens stack, 1003, was 500 arbitrary units (“a.u.”). The lenses have a diameter, 1008, of 200 a.u. Referring to inset, 1004, the compound lens stack comprised a flat-face single convex lens, 1005, having a right radius of curvature of −120 a.u. and a refractive index of 1.5; a double concave lens, 1006, having a left radius of curvature of −120 a.u. and a right radius of curvature of +200 a.u. and a refractive index of 1.7; and a double convex lens, 1007, having a left radius of curvature of +200 a.u., a right radius of curvature of −200 a.u. and a refractive index of 1.5. The total thickness, 1009, of the compound lens stack was 106 a.u. Using a thin lens approximation, this compound lens has an infinite focal length.

The image, 1000, shows that the array of compound lenses provided minimum distortion of the emitted light. A surface comprising many of these or similar compound lenses would have sufficient roughness to provide both glare- and smudge-resistance. Simulations were also performed from off-normal angles of incidence, which yielded similar results.

### Comparative Example A

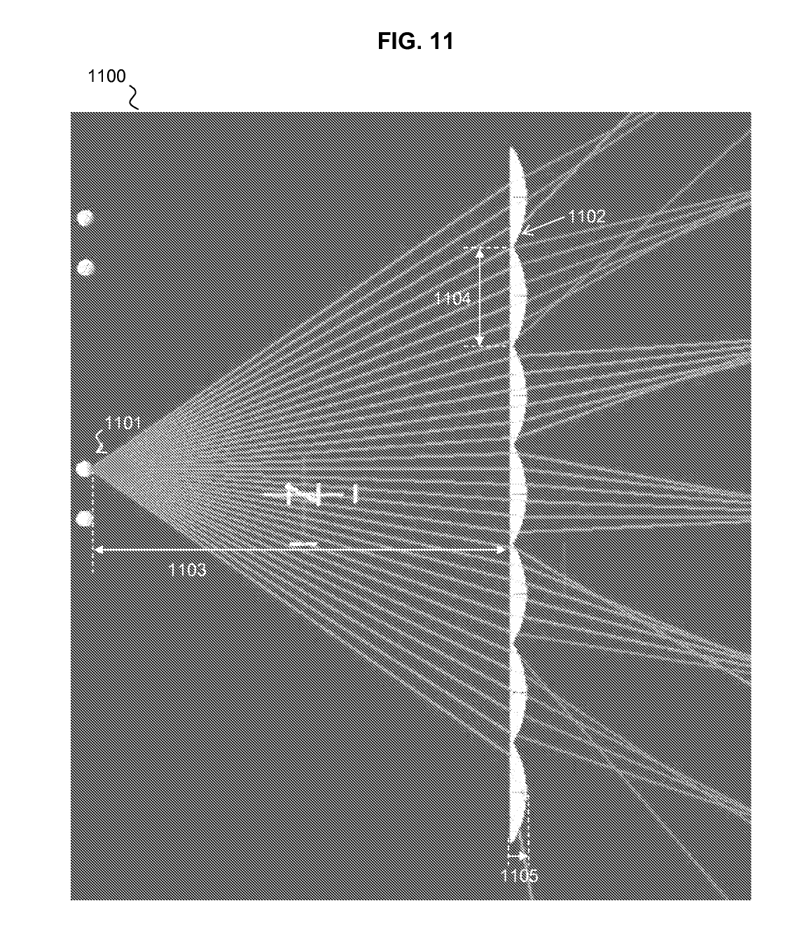

Light diffraction through a composite coating comprising optical elements of finite focal length was simulated using Optics Lab Optical Ray Tracing Software™ (Science Lab Software, Carlsbad, Calif.). FIG. 11 provides an image, 1100, of a ray-trace diagram prepared from the simulation. A point light source, 1101 (wavelength=600 nm), was projected onto an array of lenses, 1102. The distance from the light source to the lens' front surface, 1103, was 500 a.u. The lenses have a diameter, 1104, of 200 a.u. The simple lens stack comprised a flat-face single concave lens having a right radius of curvature of +300 a.u. and a refractive index of 1.5. The thickness, 1105, of the simple lens was 30 a.u.

The image, 1100, shows that the array of lenses considerably distort the emitted light, which resulted in scattering and blurring of the emitted light.

### Example 8

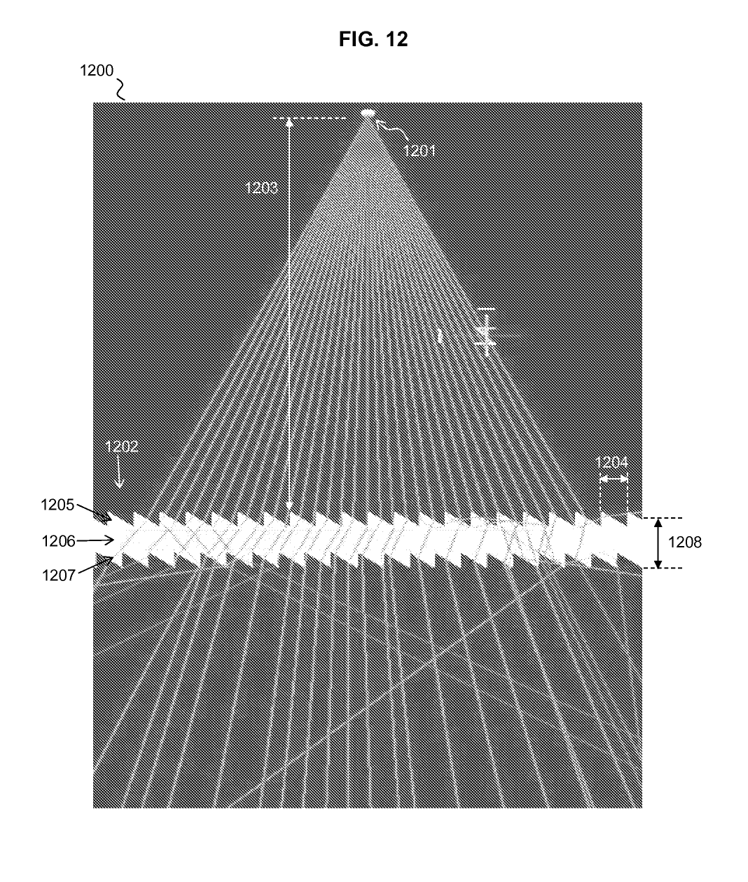

Light diffraction through a composite coating comprising optical elements of infinite focal length was simulated using Optics Lab Optical Ray Tracing Software™ (Science Lab Software, Carlsbad, Calif.). FIG. 12 provides an image, 1200, of a ray-trace diagram prepared from the simulation. A point light source, 1201 (wavelength=600 nm), was projected onto a compound array of prisms, 1202. The distance from the light source to the closest surface of the prisms, 1203, was 500 a.u. The prisms have a width, 1204, of 20 a.u. The compound array of prisms comprised a first layer comprising an array of right angle prisms, 1205, having a refractive index of 1.5; a second layer, 1206, having a refractive index of 1.5; and a third layer comprising an array of right angle prisms, 1207, having a refractive index of 1.5. The prisms are off-set from one another The total thickness, 1208, of the composite optical coating was 68 a.u.

The image, 1200, shows that the array of optical elements provided minimum distortion of the emitted light. A surface comprising many of these or similar compound lenses would have sufficient roughness to provide both glare- and smudge-resistance.

### Comparative Example B

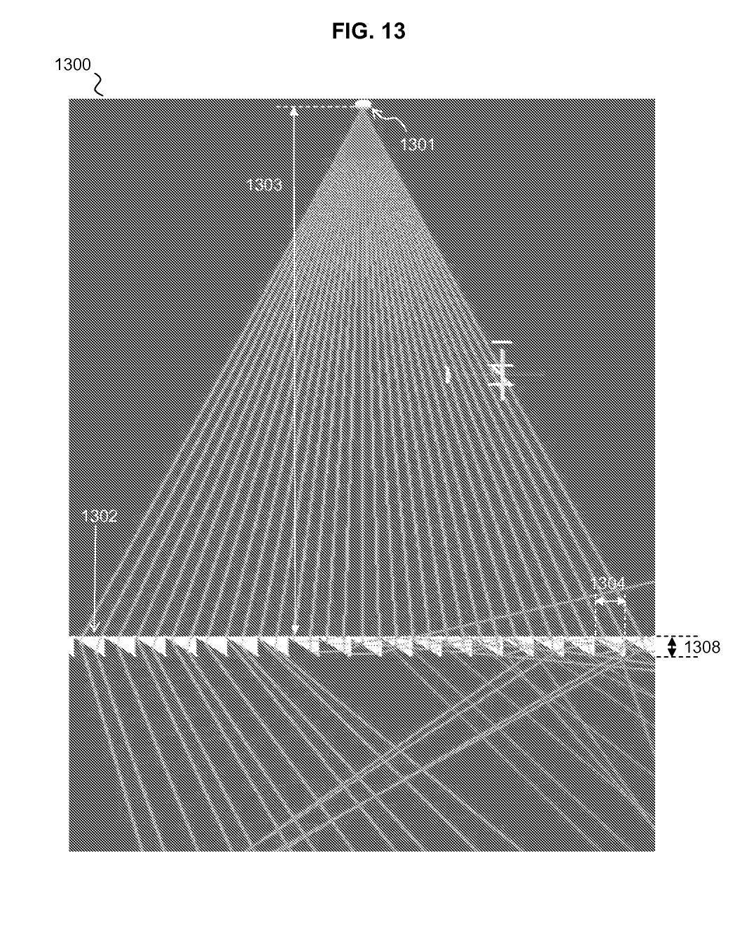

Light diffraction through a coating comprising optical elements of finite focal length was simulated using Optics Lab Optical Ray Tracing Software™ (Science Lab Software, Carlsbad, Calif.). FIG. 13 provides an image, 1300, of a ray-trace diagram prepared from the simulation. A point light source, 1301 (wavelength=600 nm), was projected onto an array of right angle prisms, 1302. The distance from the light source to the closest surface of the prisms, 1303, was 500 a.u. The prisms have a width, 1304, of 20 a.u. The array of prisms comprised a first layer comprising an array of prisms, 1302, having a refractive index of 1.5. The total thickness, 1308, of the optical coating was 20 a.u.

The image, 1300, shows that the array of compound lenses provided considerable bidirectional distortion of the emitted light.

### Comparative Example C

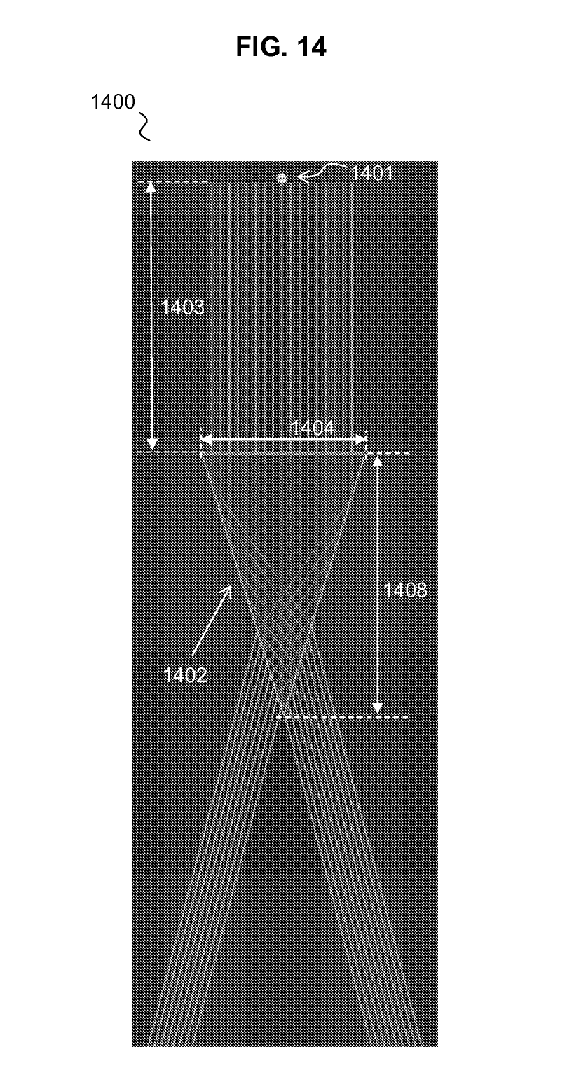

Light diffraction through a coating comprising an optical element of finite focal length was simulated using Optics Lab Optical Ray Tracing Software™ (Science Lab Software, Carlsbad, Calif.). FIG. 14 provides an image, 1400, of a ray-trace diagram prepared from the simulation. A plane light source, 1401 (wavelength=532 nm), was projected onto a prism, 1402. The distance from the light source to the closest surface of the prism, 1403, was 500 a.u. The prism has a width, 1404, of 500 a.u., and a refractive index of 1.5. The total thickness, 1408, of the prism was 400 a.u.

The image, 1400, shows that the optical element provided considerable bidirectional distortion of the emitted light.

### Comparative Example D

The result described in Comparative Example C was tested and verified experimentally using an array of optical elements similar to that shown in FIG. 14.

A flat elastomeric stamp was prepared by blanket depositing a photoresist (SU-8, MicroChem. Corp., Newton, Mass.) onto a surface of a master (30 mm diameter silicon wafer). The photoresist was patterned using conventional photolithography to produce a patterned master having thereon an array of triangular trenches having a depth of _ μm, a spacing of 100 μm, and a sidewall angle of 18.40. The patterned master was first treated with a fluorosilane, and a liquid elastomeric precursor (poly(dimethylsiloxane)) was then spin-coated onto the master while rotating at 500 rpm. The resulting coated master was cured on a hotplate for 20 minutes at 85° C., cooled to room temperature (approximately 22° C.), and the resulting flat elastomeric stamp was peeled away from the master. The flat elastomeric stamp was approximately 1 mm thick, and the patterned surface included an array of triangular trenches having a depth of 150 μm, a spacing of 100 μm, and a sidewall angle of 18.4°.

A planar 20 mm diameter glass substrate was coated with a solution of ultraviolet curable polymer. The elastomeric stamp was then contacted with the coated substrate, and the coating was hardened by curing with an ultraviolet lamp for 5 minutes. The elastomeric stamp was then removed from the substrate.

The substrate was placed 10 cm from a 532 nm laser light source and light scattering was observed. Light was scattered by the optical array of prisms in a bi-directional manner, as predicted by Comparative Example C.

### Example 9

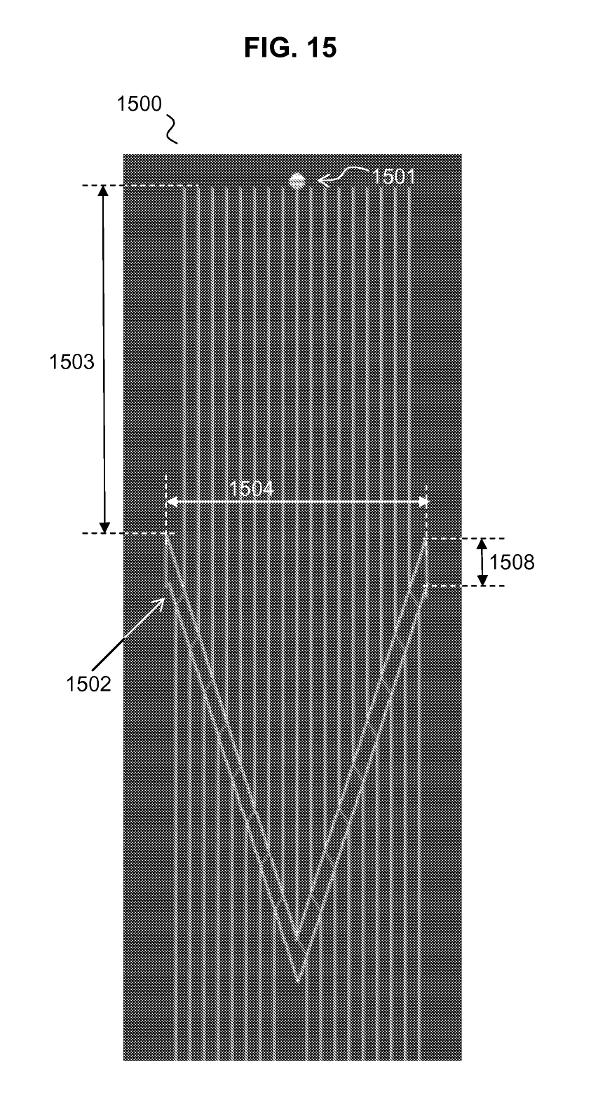

Light diffraction through a coating comprising a hollow optical element was simulated using Optics Lab Optical Ray Tracing Software™ (Science Lab Software, Carlsbad, Calif.). FIG. 15 provides an image, 1500, of a ray-trace diagram prepared from the simulation. A plane light source, 1501 (wavelength=532 nm), was projected onto a hollow optical element having a point surface, 1402. The distance from the light source to the closest surface of the hollow optical element, 1503, was 500 a.u. The hollow optical element has a width, 1504, of 500 a.u., and a refractive index of 1.5. The total thickness, 1508, of the hollow optical element was 50 a.u.

The image, 1500, shows that the hollow optical element provided minimal distortion of the emitted light, and that the image was largely after passing through the hollow optical element.

### CONCLUSION

These examples illustrate possible embodiments of the present invention. While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. A smudge-resistant, composite coating comprising:
a matrix, and
a particulate embedded within, and protruding from, at least a portion of the matrix,
wherein the particulate has a refractive index within about 20% of a refractive index of the matrix, the particulate has a polydispersity index of at least about 1 or greater, and the particulate is present within the matrix in a concentration gradient having a highest concentration at an exterior surface of the matrix, and wherein the composite coating has a root mean square surface roughness of about 100 nm to about 10 μm.

2. The composite coating of claim 1, wherein the matrix has a refractive index of about 2 or less.

3. The composite coating of claim 1, wherein the matrix has a glass transition temperature of about 50° C. to about 250° C.

4. The composite coating of claim 1, wherein the particulate has a D₅₀ of about 100 nm to about 50 μm and a D₉₀ of about 100 μm or less

5. The composite coating of claim 1, wherein the matrix has a hardness and the particulate has a hardness at least about 2 times greater than the hardness of the matrix.

6. The composite coating of claim 1, wherein an exterior surface of the composite coating comprises a fluorinated moiety.

7. The composite coating of claim 1, wherein an exterior surface of the composite coating is substantially free of an additional surface coating.

8. A method for preparing a smudge-resistant, composite coating, the method comprising:
depositing a particulate and a matrix to provide an intermediate film; and
curing the intermediate film to provide a smudge-resistant, composite coating,
wherein the curing embeds the particulate at least partially in the matrix to provide a smudge-resistant, composite coating having a concentration gradient of the particulate that is greatest at the exterior surface of the matrix, and wherein the composite coating has a root mean square surface roughness of about 100 nm to about 10 μm.

9. The method of claim 8, further comprising hardening the matrix.

10. The method of claim 9, wherein the curing and hardening are performed simultaneously.

11. The method of claim 8, wherein the curing provides a particulate having a D₅₀ of about 200 nm to about 50 μm.

12. A distortion-free, smudge-resistant optical coating comprising a substrate having an array of optical elements thereon, the optical elements having an infinite focal length and each optical element having a lateral dimension, measured parallel to the substrate, of about 5 μm to about 200 μm, wherein the optical coating has a root mean square surface roughness of about 1 μm to about 100 μm.

13. The distortion-free, smudge-resistant optical coating of claim 12, wherein the array of optical elements is selected from: an array of compound lenses, an array of prisms, a sawtooth grating, a square-wave grating, a sigmoidal grating, an array of trigonal pyramids, an array of square pyramids, and combinations thereof.

14. The distortion-free, smudge-resistant optical coating of claim 12, wherein an exterior surface of the array of optical elements comprises a fluorinated moiety.

15. The distortion-free, smudge-resistant optical coating of claim 15, wherein the array of optical elements comprises aligned layers of materials that are the same or different, and wherein each layer has a refractive index of about 3 or less.

16. A method for preparing a distortion-free, smudge-resistant optical coating, the method comprising forming on a substrate a layer comprising an array of optical elements, wherein the substrate and the layer are transparent to visible light, wherein the optical elements have an infinite focal length, the optical elements have a lateral dimension, measured parallel to the substrate, of about 5 μm to about 200 μm, and the layer has an exterior surface having a root mean square surface roughness of about 1 μm to about 100 μm.

17. The method of claim 16, wherein the forming comprises:
depositing a first layer of a first material on the substrate, wherein the first layer includes a surface having a first three-dimensional pattern thereon;
depositing a second layer of a second material on the first layer, wherein the second material includes a surface having a second three-dimensional pattern thereon;
depositing a third layer of a third material on the second layer, wherein the third layer includes a surface having a third three-dimensional pattern thereon,
wherein the first, second and third three-dimensional patterns are optically aligned to provide an array of optical elements having an infinite focal length, and wherein the first, second and third materials are transparent to visible light.

18. The method of claim 16, wherein the forming comprises molding a material with an elastomeric stamp including a surface having at least one indentation therein to provide the array of optical elements.

19. The method of claim 16, wherein the optical coating has a refractive index less than a refractive index of the substrate.

20. A method for preparing a smudge-resistant film, the method comprising:
depositing a matrix onto a substrate; and
exposing the matrix to an abrasive to produce the smudge-resistant film, wherein the film has a root mean square surface roughness of about 100 nm to about 10 μm.

21. The method of claim 20, further comprising at least one of: chemically, mechanically, or thermally polishing the smudge-resistant film.

22. The method of claim 20, further comprising surface treating the smudge-resistant film to render an exterior surface of the film hydrophobic.

23. A distortion-free, smudge-resistant coating comprising a substrate that is transparent to visible light and having an array of hollow, pointed elements thereon, each element having a height of about 1 μm to about 300 μm and a thickness of about 100 nm to about 100 μm, wherein the thickness of the elements is not more than 30% of the height of the elements, and wherein the elements do not substantially overlap, and wherein the elements comprise a material having a refractive index that is either less than, or not more than 20% greater than, a refractive index of the substrate.
